(19) United States
(12) Patent Application Publication
(10) Pub. No.: US 2006/0004743 A1
(43) Pub. Date: Jan. 5, 2006

(54) Remote control system, controller, program product, storage medium and server

(75) Inventors: Hiroya Murao, Hirakata-City (JP); Youichiro Nishikawa, Katano-City (JP); Kazumi Ohkura, Nara-City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO Electric Co., Ltd., Moriguchi-shi (JP)

(21) Appl. No.: 11/152,410

(22) Filed: Jun. 15, 2005

(30) Foreign Application Priority Data
Jun. 15, 2004 (JP) 2004-177585
Apr. 26, 2005 (JP) 2005-128464

(51) Int. Cl. G06F 17/30

(52) U.S. Cl. 707/4

(57) ABSTRACT

When a voice is inputted to an operation terminal (200), the audio input is subjected to voice recognition in a voice recognizing unit (107) and keywords are extracted. A search condition creating unit (110) creates a search condition from the extracted keywords. A search unit (111) searches for control items that can be options to choose from. These control items are displayed on a television screen by an output information creating unit (113). A user uses the operation terminal (200) as a pointing device to select and point a desired control item among the displayed control items. Thereafter, a “select” key of operation keys is operated to obtain control codes for this control item. The control codes are sent to a television set (300).

### BACKGROUND OF THE INVENTION

1. Field of the Invention

The present invention relates to a remote control system, a controller, a program for giving a computer a controller function, a storage medium storing the program, and a server. More specifically, the present invention relates to a technique suitable for use in remote operation of home electric appliances.

2. Description of the Related Art

Generally speaking, it is often done via a remote controller that operation commands are inputted to a home electric appliance. Wireless remote controllers enable users of appliances to input operation commands wherever they are, and thus are enhanced in user-friendliness.

On the other hand, recent multifunctional appliances are complicating remote controller operation considerably. This is particularly notable in digital TVs and other IT appliances where not only operation buttons are departmentalized but also control items are hierarchized. Such an appliance puts a user through a hassle of choosing correct operation buttons to input one control item and requires a user to press many different operation buttons until the objective layer is reached. Because of the laboriousness of operating remote controllers in digital TVs and other IT appliances, the remote controllers are losing their convenience, for which they have been provided in the first place, especially to those who are not familiar with operating IT appliances such as older people.

In a digital television set, it takes a while for a user to reach the objective program since there are so many channels and programs. The digital television set may be equipped with functions that help a user to choose a program, such as a function of selecting genres, but these functions are hierarchized, thereby necessitating operation of plural key store ad an objective function. In addition, the hierarchized functions require meticulous reading of the TV's manual or the like to find out which key is assigned to which function before an objective function can be called up.

To address this problem, JP 2000-316128 A has disclosed a control system that allows a user to input operation commands with his/her voice. This control system has a function of comparing a broadcast program name in broadcast program information received by EPG receiving means against a voice signal recognized by a voice recognizing/converting unit and, when the two match, setting the broadcast program name in question and its relevant data (i.e., the date the broadcast program is on air, the start time and end time, and the station of the broadcast program) as data for program-recording the broadcast program.

This control system eliminates the need for laborious button operation and improves the user-friendliness of a remote controller.

However, the above control system cannot avoid an erroneous recognition in voice recognition, and a wrong control command may be set in a video recorder, with the result that the video recorder is programmed to record a wrong broadcast program. Then, the user has to put up with the inconvenience of performing additional operations such as canceling the wrongly programmed recording and re-programming.

### SUMMARY OF THE INVENTION

The present invention has been made to solve the inconveniences described above, and an object of the present invention is therefore to provide a remote control system that ensures that an objective operation command is inputted with simple operation and thereby improves the user friendliness markedly.

According to a first aspect of the present invention, there is provided a remote control system with an operation terminal and a controller which outputs control information for controlling an appliance in accordance with an operation command inputted to the operation terminal, including: audio inputting means for inputting audio information; instruction inputting means for selecting and designating an item displayed on a screen; candidate creating means for creating a group of candidate items which can be options to choose from, from the audio information inputted to the audio inputting means; image information creating means for creating image information from the candidate item group created by the candidate creating means; display means for displaying, on the screen, the image information created by the image information creating means; determining means for determining which control item in the candidate item group displayed on the screen by the display means is selected and designated by the instruction inputting means; and control information outputting means for outputting control information according to the control item that is determined by the determining means.

According to a second aspect of the present invention, there is provided a remote control system according to the first aspect, in which the candidate creating means includes: database means for storing control items in association with keywords; text composing means for composing text data by using the audio information inputted from the audio inputting means; and candidate extracting means for comparing the text data composed by the text composing means against keywords of control items stored in the database means, and extracting as candidates to choose from, control items that contain keywords matching a character string in the text.

According to a third aspect of the present invention, there is provided a remote control system according to the first aspect, in which the candidate creating means includes: a synonym database for storing synonyms in association with keywords; a control item database for storing control items in association with keywords; text composing means for composing text data from the audio information inputted from the audio inputting means; synonym displaying means for comparing the text data composed by the text composing means against keywords of synonyms stored in the synonym database to extract, as candidates to choose from, synonyms that are associated with keywords matching a character string in the text, and displaying the extracted synonyms on the screen as options to choose from; and candidate extracting means for comparing synonyms that are designated by selection from the synonyms displayed on the screen by the synonym displaying means against keywords of control items stored in the control item database, and extracting, as candidates to choose from, control items that contain keywords matching a character string in the text.

Besides, the characteristics of the remote control system according to the above aspects of the present invention may be viewed individually as a characteristic of any controller or terminal device constituting the system. The characteristics may also be viewed as a program to give a computer functions of the aspects of the present invention, or as a storage medium storing the program. In the case where an external server is to have a function of extracting a group of candidate items which can be options to choose from, the characteristics may be viewed as characteristics of the server.

According to the present invention, a group of candidate items which are options to choose from is created by an audio input and then an objective control item is chosen from the group by instruction inputting means. Therefore, numerous and hierarchized control items can easily be narrowed down to a few candidate items and, by choosing the desired one from the candidate items, the objective control command can correctly be set in the appliance.

An erroneous recognition could happen during voice recognition in the present invention as in prior art, but, in the present invention, incongruent control items contained in a candidate item group as a result of the erroneous recognition is screened out leaving only proper control items. Therefore, incongruent control items mixed in a candidate item group does not cause a serious problem. On the contrary, the merit of simple operation that audio inputting solely by which a candidate item group is presented will strongly appeal to users.

### BRIEF DESCRIPTION OF THE DRAWINGS

The aforementioned and other objects and novel characteristics of the present invention will be understood more clearly by the following description of embodiments when read in conjunction with the accompanying drawings in which:

FIG. 1 shows the configuration of a remote control system according to a first embodiment;

FIG. 2 shows function blocks of a remote controller terminal and a controller;

FIG. 3 shows a configuration example of a television set control command DB;

FIG. 4 shows a configuration example of a television program searching DB;

FIG. 5 shows a directory configuration of control items;

FIG. 6 is a flow chart showing the operation of a controller;

FIG. 7 is a diagram illustrating control item search processing;

FIG. 8 shows an operation example of a remote control system;

FIG. 9 shows the configuration of a remote control system according to another embodiment;

FIG. 10 shows the configuration of a remote control system according to still another embodiment;

FIG. 11 shows the configuration of a remote control system according to yet still another embodiment;

FIG. 12 shows function blocks of an external server;

FIG. 13 is a flowchart showing the operation of a remote control system;

FIG. 14 shows a configuration example of a display screen according to a second embodiment;

FIG. 15 shows function blocks of a remote controller terminal and a controller according to the second embodiment;

FIG. 16 shows a data configuration of a synonym DB according to the second embodiment;

FIG. 17 is a flow chart showing the operation of a controller according to the second embodiment;

FIG. 18 is a processing flowchart of an audio processing routine according to the second embodiment;

FIG. 19 is a flow chart of synonym expansion processing according to the second embodiment;

FIG. 20 is a processing flow chart of a key information processing routine according to the second embodiment;

FIG. 21 is a flowchart of search condition creating processing according to the second embodiment;

FIG. 22 is a flowchart of assist operation processing according to the second embodiment;

FIGS. 23A and 23B show display examples of an assist operation processing screen according to the second embodiment; and

FIG. 24 shows an operation example of a remote control system according to the second embodiment.

### DETAILED DESCRIPTION OF THE PREFERRED EMBODIMENTS

Embodiments of the present invention will be described below with reference to the accompanying drawings. However, the following embodiments are provided for exemplification only, and are not to limit the scope of the present invention.

### First Embodiment

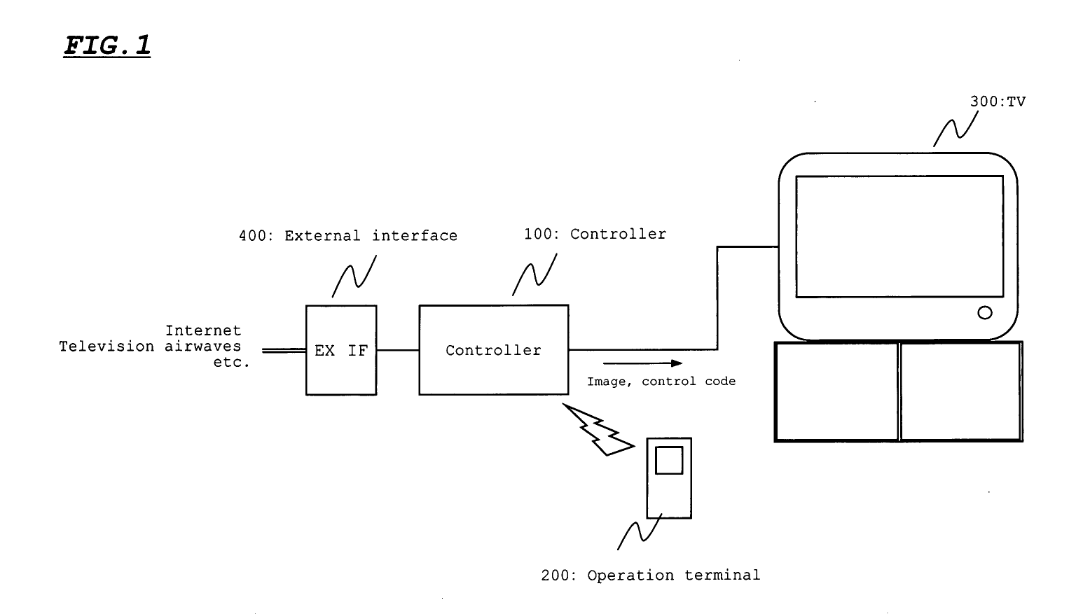

FIG. 1 shows the configuration of a control system according to a first embodiment.

As shown in FIG. 1, this control system is composed of a controller 100, an operation terminal 200, a television (digital television) set 300 and an external interface 400.

This control system is for remotely controlling the function or operation state of the television set 300 with the operation terminal 200. The operation terminal 200 outputs electric wave signals in accordance with how the operation terminal 200 is operated to the controller 100. The controller 100 receives the electric wave signals and execute processing in accordance with how the operation terminal 200 is operated.

The operation terminal 200 has, in addition to operation keys, a microphone to make audio inputting possible. The operation terminal 200 also has a built-in gyroscope, so that when swung up or down or to the left or the right, the operation terminal 200 outputs a displacement signal in accordance with the motion. Thus, besides being key input means, the operation terminal 200 can serve as audio input means or a pointing device.

In this control system, when a voice is inputted through the microphone, control items relevant to the audio input are extracted by the controller 100 and displayed on the television set 300. To elaborate, the controller 100 has a voice recognizing function and a search function to search databases in accordance with the result of voice recognition and extract, as control target candidates, control items that are associated with keywords contained in the audio input. The extracted control item group is displayed on the television set 300.

A user operates the operation terminal 200 as a pointing device to point a desired control item out of the control item group displayed on the display screen. By pressing a “select” key on the operation terminal 200 with the desired control item pointed (designated), a function according to the control item is set in the TV.

The databases consulted by the controller 100 to extract control items are a database related to functions of the TV and a database related to broadcast programs. The database related to broadcast programs is updated to the latest version by obtaining EPG (electronic program guide) or the like from an external network via the external interface 400.

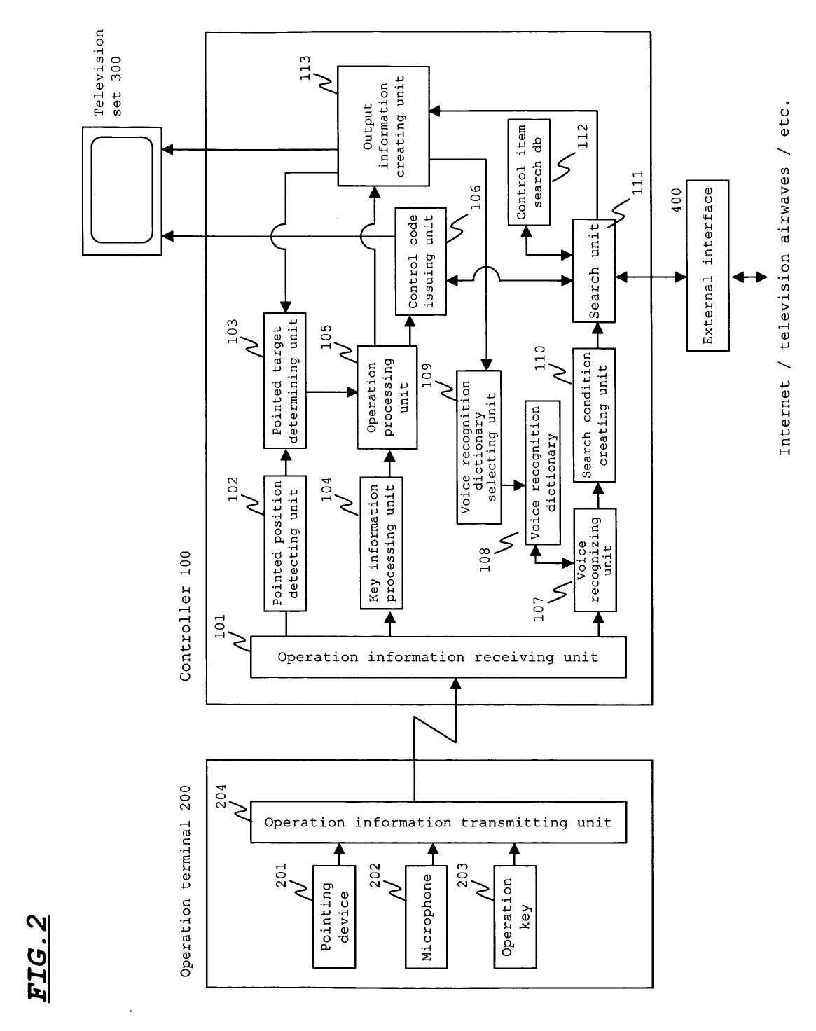

FIG. 2 is a function block diagram of the controller 100 and the operation terminal 200.

In FIG. 2, a pointing device 201 contains a gyroscope as mentioned above and outputs information on displacement of the operation terminal 200 (pointing information) to an operation information transmitting unit 204. A microphone 202 converts an inputted voice into audio information, which is outputted to the operation terminal transmitting unit 204. Operation keys 203 outputs information on key operation by a user (key information) to the operation terminal transmitting unit 204. The operation terminal transmitting unit 204 outputs, as electric wave signals, the pieces of information received from the pointing device 201, the microphone 202, and the operation keys 203 together with identification information, which indicates by which means the information is inputted. The operation terminal transmitting unit 204 may output infrared-ray signals instead of electric wave signals.

An operation information receiving unit 101 receives electric wave signals sent from the operation control terminal 200 to obtain operation information. The obtained information is outputted to any one of a pointed position detecting unit 102, a key information processing unit 104 and a voice recognizing unit 107. In the case where identification information that is received along with the operation information indicates the pointing device, pointing information is obtained from the received signals and outputted to the pointed position detecting unit 102. In the case where the identification information indicates the operation keys, key information is obtained from the received signals and outputted to the key information processing unit 104. In the case where the identification information that is received along with the operation information indicates the microphone, audio information is obtained from the reception signals and outputted to the voice recognizing unit 107.

The pointed position detecting unit 102 detects the current pointed position on the screen based on the pointing information received from the operation information receiving unit 101, and outputs the result of the detection to a pointed target determining unit 103. To elaborate, the pointed position detecting unit 102 uses the pointing information to calculate how far and in what direction the pointed position has moved from a reference position on the display screen, and uses this calculation result to calculate the coordinates (coordinates on the display screen) of the pointed position at present. The thus calculated current pointed position is outputted to the pointed target determining unit 103.

The pointed target determining unit 103 determines, from the pointed position information received from the pointed position detecting unit 102, which item out of items displayed on the screen is designated at present, and outputs the result to an operation processing unit 105. To elaborate, the pointed target determining unit 103 uses association information, which is provided by an output information creating unit 113 and which associates control items displayed on the display screen with their display areas, to determine which control item is associated with a display area that contains the pointed coordinates provided by the pointed position detecting unit 102. The control item determined as associated with this display area is outputted to the operation processing unit 105 as a determined result.

The key information processing unit 104 performs interpretation processing on the key information received from the operation information receiving unit 101, and outputs information indicative of how the keys are operated to the operation processing unit 105.

Based on the information received from the pointed target determining unit 103 or the key information processing unit 104, the operation processing unit 105 outputs command information to a control code issuing unit 106 or the output information creating unit 113 as follows:

In the case where the result received from the pointed target determining unit 103 indicates the same control item for a given period of time or longer, the operation processing unit 105 outputs, to the output information creating unit 113, a command to have this control item enlarged and displayed on the screen. When a given period of time passes after the control item is displayed enlarged, the operation processing unit 105 outputs, to the output information creating unit 113, a command to stop displaying the control item enlarged.

In the case where the information received from the key information processing unit 104 is for operation of keys other than the “select” key (for example, volume up/down keys or channel keys), the operation processing unit 105 outputs, to the control code issuing unit 106, a command to have the unit 106 issue a control code that conforms to the key definition. In the case where the information received from the key information processing unit 104 indicates that the “select” key has been operated, the operation processing unit 105 outputs, to the control code issuing unit 106, along with the information that the pointed target determining unit 103 has sent to indicate which control item is the pointed target, a command to have the unit 106 issue a control code corresponding to this control item.

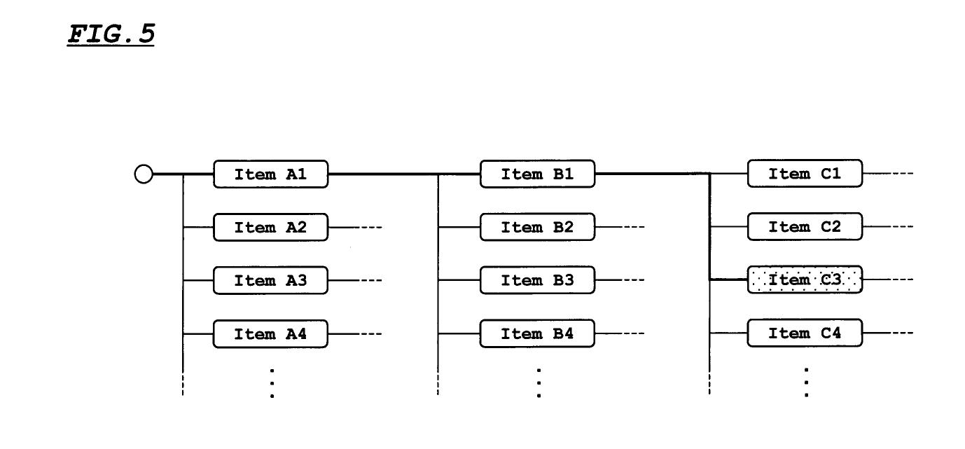

The control code issuing unit 106 outputs a control code to the television set 300 in accordance with a command input from the operation processing unit 105. The control code issuing processing will be described later in detail with reference to the process flow of FIG. 5.

The voice recognizing unit 107 uses audio information received from the operation information receiving unit 101 to perform voice recognition on a voice inputted via the microphone, and outputs the recognition result to a search condition creating unit 110. To elaborate, the voice recognizing unit 107 performs voice recognition processing on the voice inputted using dictionary information of a voice recognition dictionary that is chosen by a voice recognition dictionary selecting unit 109. Through the voice recognition processing, keywords are extracted from a string of characters of the inputted voice, and the text data is outputted to the search condition creating unit 110.

A voice recognition dictionary 108 is a recognition dictionary consulted by the voice recognizing unit 107 during voice recognition processing, and is constituted of terms or character strings that are expected to be used in setting the function or operation state of a television set. The voice recognition dictionary 108 is structured such that the voice recognition dictionary selecting unit 109 can choose and set which dictionary information is to be consulted by the voice recognizing unit 107 in accordance with instruction information sent from the output information creating unit 113. For instance, each piece of directory information is stored in association with a control item so that only pieces of dictionary information that are associated with control items necessary for voice recognition are chosen. Also, various attributes may be set to pieces of dictionary information so that dictionary information is chosen by its attributes.

The voice recognition dictionary selecting unit 109 chooses and sets which dictionary information of the voice recognition dictionary 108 is to be consulted by the voice recognizing unit 107 in accordance with instruction information sent from the output information creating unit 113. For instance, of pieces of dictionary information contained in the voice recognition dictionary 108, the voice recognition dictionary selecting unit 109 chooses only ones that are associated with control items displayed on the TV screen, and sets them as dictionary information to be consulted by the voice recognizing unit 107.

The search condition creating unit 110 creates a search condition from keywords inputted from the voice recognizing unit 107, and outputs the created search condition to a search unit 111. The search unit 111 consults a control item (command) search DB 112 to extract control items that match the keywords inputted from the voice recognizing unit 107. The search unit 111 also obtains broadcast program information such as EPG via the external interface 400 and, using the obtained information, updates a database related to broadcast program information in the control item search DB 112.

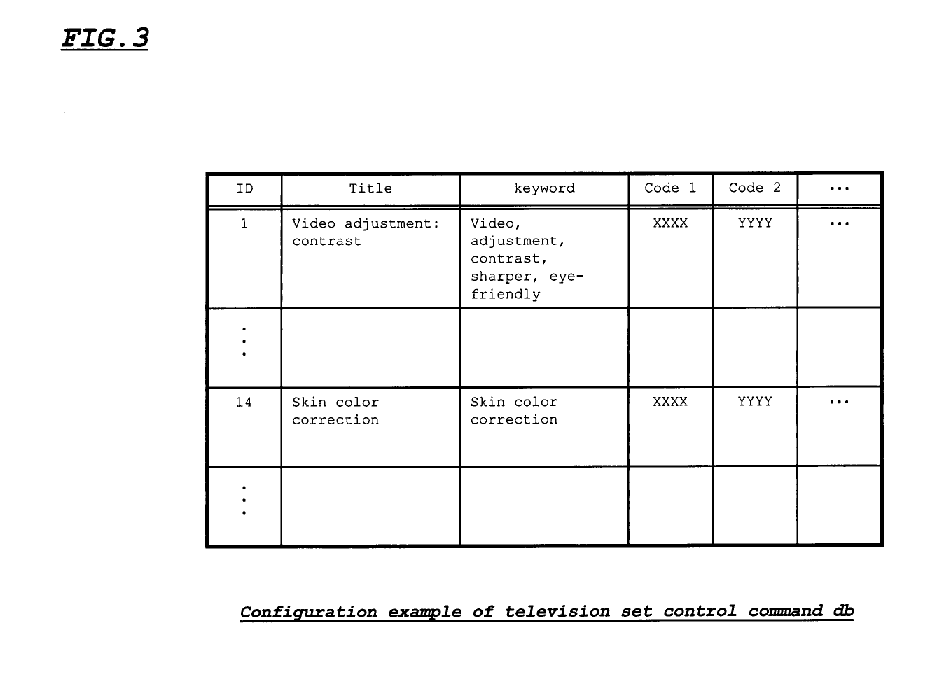

The configuration of the control item search DB 112 and how to search for control items with the use of the DB 112 will be described later in detail with reference to FIGS. 3, 4 and 6.

The output information creating unit 113 uses the control items extracted by the search unit 111 to create display information for displaying the extracted control items on the television screen, and outputs the created display information to the television set 300. As described above, the output information creating unit 113 also uses the extracted control items to create the association information, which associates control items displayed on the display screen with their display areas, and outputs the created association information to the pointed target determining unit 103. Another function of the output information creating unit 113 is, as described above, to output, to the voice recognition dictionary selecting unit 109, a command to select and set only pieces of dictionary information that are relevant to the currently displayed control items as dictionary information that is to be consulted by the voice recognizing unit 107.

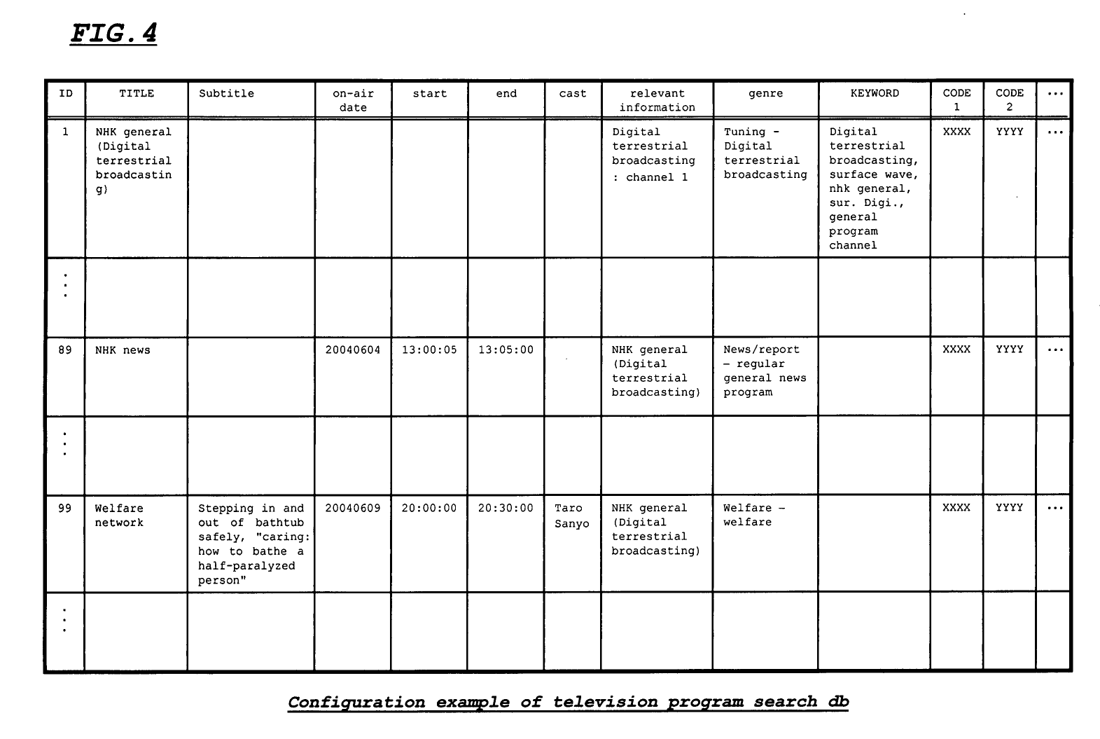

FIGS. 3 and 4 show a data configuration of the control item search DB 112.

FIG. 3 shows the configuration of a television set control command DB (a database related to functions of the television set). As shown in FIG. 3, the television set control command DB is composed of IDs of control items, titles of control items, keywords assigned to control items, and control codes for setting a function according to a control item in the television set.

Plural control codes (Code 1, Code 2 . . . ) are associated with one control item because the control item directory is hierarchized. Here, referring to FIG. 5, under the present circumstances, in the case where Item C3, which is in the third layer, is to be set in the television set, this third layer control item (Item C3) cannot be set until after Code 1 and Code 2, which are control codes associated with control items in the first and second layers of this directory (Item A1 and Item B1), are sequentially transmitted to and set in the television set. For that reason, in the television set control command DB shown in FIG. 3, control codes necessary to set a control item that is associated with an ID in question are written in an ascending order of the hierarchy (Code 1, Code 2 . . . ). Thus, the control item associated with the ID in question can be set in the television set by transmitting the codes to the television set in order.

If a future technical development makes it possible to set a function associated with a control code in a television set by transmitting only the objective control code instead of trailing down a directory until this control code is reached, it eliminates the need to enter plural control codes for one control item as in FIG. 3. In this case, entered for one control item is a control code for setting a function of this control item, and no other control codes are registered for this control item.

FIG. 4 shows the configuration of a television program search DB. As shown in FIG. 4, the television program search DB is composed of television programs' IDs, titles, subtitles, on-air dates, start time, end time, casts, relevant information, genres, keywords, and control codes (Code 1, Code 2 . . . ). Plural control codes (Code 1, Code 2 . . . ) are associated with one television program for the same reason as described above in regard to the television set control command DB.

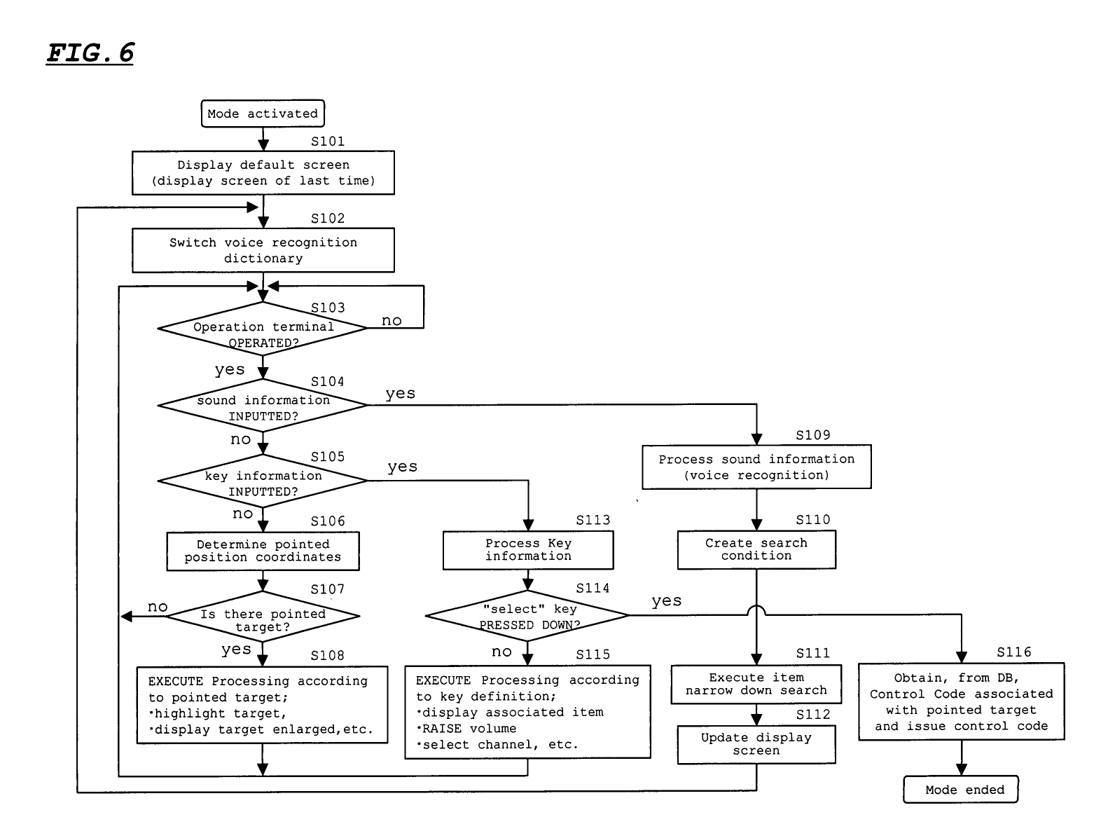

Described next with reference to FIG. 6 is how this control system operates.

As a control mode is activated, first, the output information creating unit 113 causes the television screen to display a default screen (step S101). In the case where the control mode is activated in order to reset previous control operation, a screen of one step before is displayed as a default screen. Then items displayed one step before are displayed on the television screen as they have been.

In the case where items displayed one step before are displayed on the screen, the output information creating unit 113 outputs, to the voice recognition dictionary selecting unit 109, a command to select and set only pieces of dictionary information that are relevant to the displayed items. Receiving the command, the voice recognition dictionary selecting unit 109 selects, from pieces of dictionary information of the voice recognition dictionary 108, only those relevant to the displayed items and sets them as dictionary information to be consulted by the voice recognizing unit 107 (step S102).

Thereafter, the controller 100 judges whether or not operation information has been received from the operation terminal 200 (step S103). When it is judged that operation information has been received from the operation terminal 200 (step S103: yes), the controller 100 judges which one of the pointing device 201, the microphone 202, and the operation keys 203 has provided the operation information (steps S104 and S105). When the operation information is judged as audio information provided by the microphone 202 (step S104: yes), the voice recognizing unit 107 performs voice recognition based on dictionary information that is chosen and set by the voice recognition dictionary selecting unit 109, and extracts terms (keywords) contained in the voice inputted (step S109). The extracted keywords are outputted to the search condition creating unit 110.

The search condition creating unit 110 creates a search condition from the received keywords, and outputs the created search condition to the search unit 111 (step S110). The search unit 111 uses the search condition to search the control item search DB 112 for control items that match the keywords (step S111). The retrieved control items are outputted to the output information creating unit 113.

The output information creating unit 113 creates a display screen containing the received control items, and sends the created display screen to the television set 300 to be displayed on the television screen (step S112). At the same time, the output information creating unit 113 creates association information which associates controlled items displayed on the display screen with their display areas, and outputs the created association information to the pointed target determining unit 103.

A control item is displayed in a manner that makes a title, a subtitle, etc. in the databases shown in FIGS. 3 and 4 included as text in displayed items. For instance, when a control item related to a television set function is displayed, a title in the television set control command DB shown in FIG. 3 is included as text in displayed items. To give another example, when a control item related to a television program is displayed, a title, a subtitle, etc. in the television program search DB shown in FIG. 4 are included as text in displayed items.

When the operation information received from the operation terminal 200 is judged as pointing information provided by the pointing device 201 (step S104: no, step S105: no), the pointed position detecting unit 102 calculates pointed position coordinates from the pointing information, and outputs the calculation result to the pointed target determining unit 103 (step S106).

The pointed target determining unit 103 uses the received pointed position coordinates and target information received from the output information creating unit 113 to judge whether or not a control item is at the pointed position (step S107). When it is judged that a control item is at the pointed position (step S107: yes), the output information creating unit 113 highlights this control item. In the case where this control item is kept designated for a given period of time or longer, the control item is displayed enlarged (step S108). While a control item is displayed enlarged, casts, relevant information and other information in the database of FIG. 4 that are not included in displayed items during normal display are also included as text in displayed items.

When the operation information received from the operation terminal 200 is judged as key information provided by the operation keys 203 (step S104: no, step S105: yes), the key information processing unit 104 interprets the key information and outputs, to the operation processing unit 105, information indicating how the keys have been operated (step S113). In the case where the received information is for operation of keys other than the “select” key (for example, volume up/down keys or channel keys) (step S114: no), the operation processing unit 105 outputs, to the control code issuing unit 106, a command to have the unit 106 issue a control code that conforms to the key definition (step S115).

On the other hand, in the case where the received information indicates that the “select” key has been operated (step s114: yes), the operation processing unit 105 outputs, to the control code issuing unit 106, along with the information that the pointed target determining unit 103 has sent to indicate which control item is the pointed target, a command to have the unit 106 issue a control code corresponding to this control item. Receiving the command, the control code issuing unit 106 picks up control codes (“Code 1”, “Code 2” . . . of FIG. 3 or FIG. 4) associated with this control item, and sequentially outputs the control codes to the television set 300 (step S116).

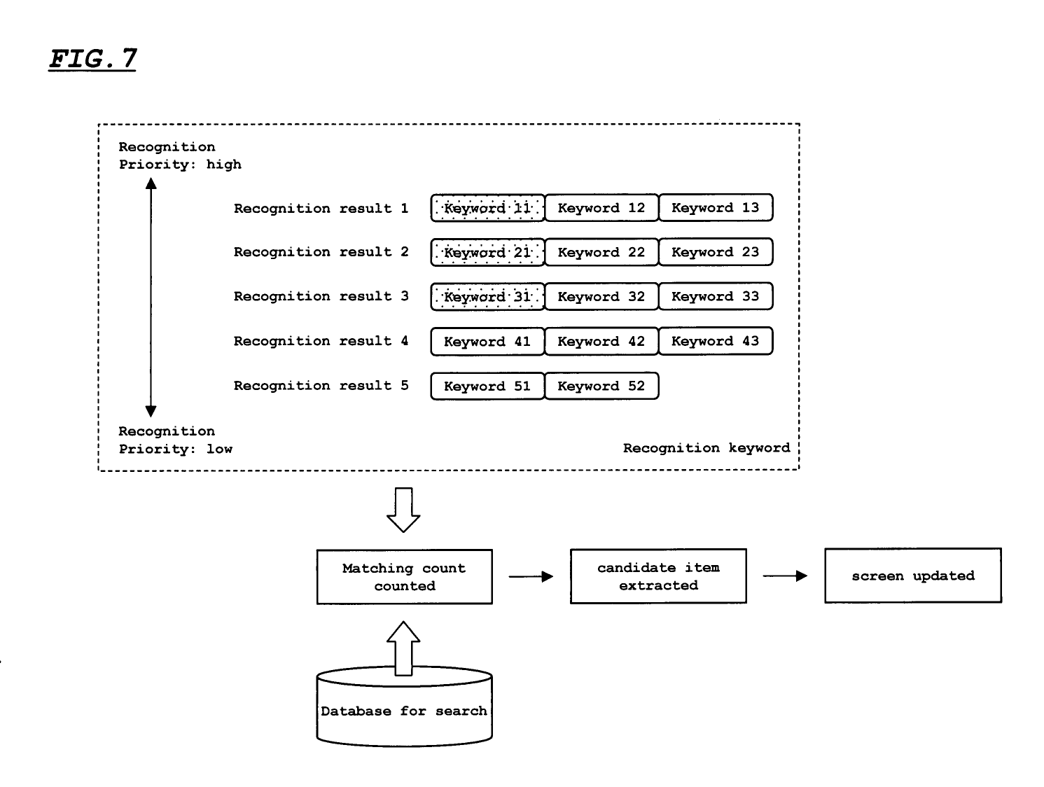

Details of the operation in steps S109 to S112 will be described next with reference to FIG. 7.

First, in the step S109, recognition results are extracted starting from the top recognition rank to the N-th rank. N is set to 5 in FIG. 7. Next, in step S110, terms contained in the recognition results (Keyword 11, Keyword 12, . . . and Keyword 52) are compared against terms of control items shown in FIGS. 3 and 4 to create a search condition for retrieving and extracting control items that match Keyword 11, Keyword 12, . . . and Keyword 52. In step S111, the search condition is used to search the control item search DB 112.

Specifically, search processing is executed as follows:

First, terms contained in control items are compared against Keyword 11, Keyword 12, . . . and Keyword 52 to count how many of Keyword 11, Keyword 12, . . . and Keyword 52 match (completely or partially) the terms contained in the control items (a matching count).

In the case of a control item belonging to the television set control command DB shown in FIG. 3, how many of Keyword 11, Keyword 12, . . . and Keyword 52 match either the “title” or “keyword” of the control item is counted. In the case of a control item belonging to the television program search DB shown in FIG. 4, how many of Keyword 11, Keyword 12, . . . and Keyword 52 match any of the “title”, “subtitle”, “cast”, “relevant information”, “genre” and “keyword” of the control item is counted.

FIG. 7 shows a case in which hatched Keyword 11, Keyword 21 and Keyword 31 out of Keyword 11, Keyword 12, . . . and Keyword 52 match terms of control items against which the keywords are compared. In this case, the matching count of the control item is 3.

In calculation of a matching count, each of the recognition results from the top recognition rank to the N-th rank may be weighted in accordance with its recognition priority level. For instance, weights a1, a2 . . . and an are set in order from the top, so that the matching count of keywords in the top recognition result is multiplied by a1, the matching count of keywords in the second recognition result is multiplied by a2, . . . and the matching count of keywords in the N-th recognition result is multiplied by an. Thereafter, all the weighted matching counts are summed up, and the total is used as the matching count of the control item in question. Instead of weighting recognition results uniformly in accordance with the recognition priority order, recognition results may be weighted in accordance with their respective recognition scores (values indicating the precision of voice recognition), for example.

Once the matching count is obtained for every control item in this manner, the next step is step S112 where the matching counts of the control items are compared against one another to arrange the control items in a descending order by the matching count on the display screen. The display screen is displayed on the television screen to present control items that are options to choose from to the user.

A control item having a smaller matching count than a threshold may be removed from the group of control items to be displayed. In the case where extracted control items are about television programs, a control item that is found not to be broadcast currently by consulting the date, start time and end time of the control item may be removed from the group of control items to be displayed.

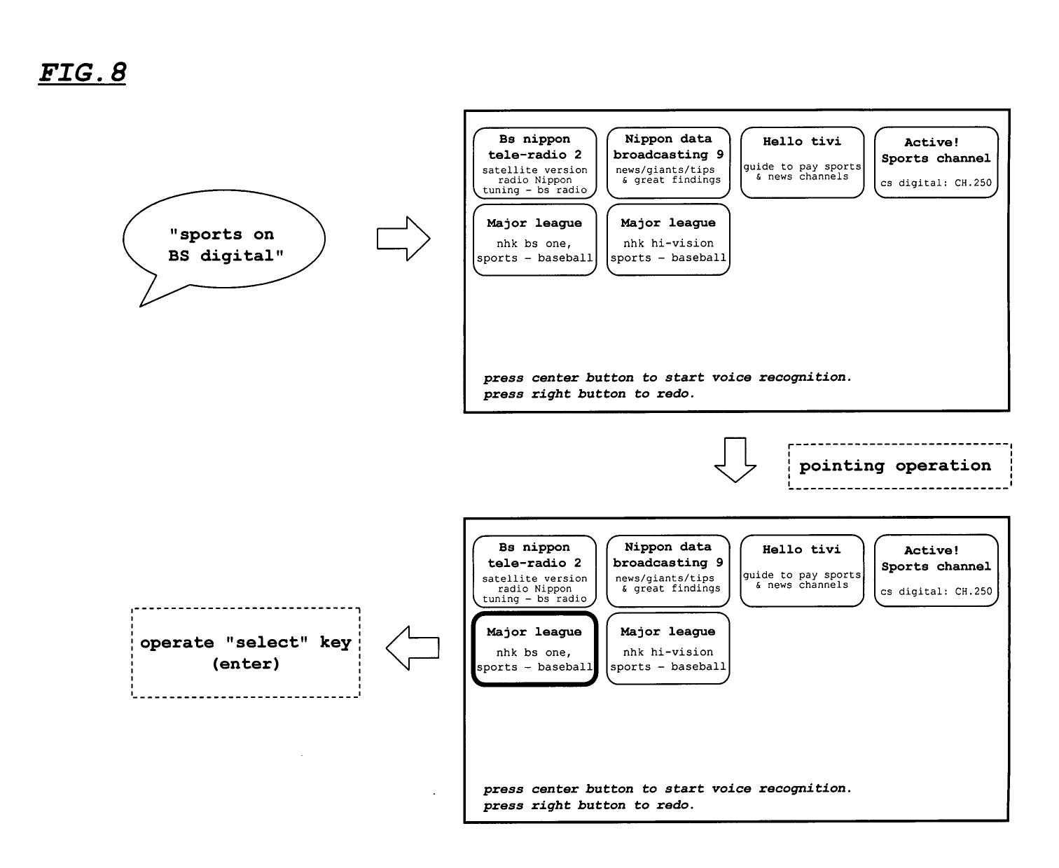

FIG. 8 shows a specific example of how this remote control system operates.

As the user speaks into the microphone 202 of the operation terminal 200 and inputs “sports programs on BS digital” with his/her voice (the upper left corner of FIG. 8), voice recognition results of the audio input are compared against terms of control items in the control item search DB 112, and control items that are options to choose from are displayed on the television screen (the upper right corner of FIG. 8).

Presented with the display, the user operates the operation terminal 200 as a pointing device to point some of the control items displayed on the display screen. The pointed control items are sequentially highlighted (the lower right corner of FIG. 8). If, at this point, the same control item is pointed for a given period of time or longer, this control item is displayed enlarged and more detailed information about this control item, such as relevant information and casts, is presented to the user.

Thereafter, while pointing a desired control item, the user operates the “select key” of the operation terminal 200 (the lower left corner of FIG. 8) to obtain control codes (Code 1, Code 2 . . . ) of this control item and sequentially transmit the control codes to the television set 300. A function according to this control item is thus set in the television set 300. In FIG. 8, the channel of the television program “Major League” broadcast by NHK BS One is set in the television set 300.

As described above, according to the remote control system of this embodiment, a desired control function is set in a television set by using an audio input to roughly narrow down options to choose from and then operate the “select key” while pointing a desired item with the pointing device. Therefore, a desired function from a diversity of operation functions, or a desired program from numerous broadcast program, as in digital television can easily be set in a television set without difficulties. The remote control system is thus improved in user-friendliness.

The controller 100, which, in the above embodiment, is composed of function blocks, may be a device dedicated to execute functions such as a set top box, or may be a program and a database that are installed in a general-purpose computer such as a personal computer to execute those functions. The program and the database may be stored in a memory medium such as a CD-ROM or may be obtained by data communications via the Internet or the like.

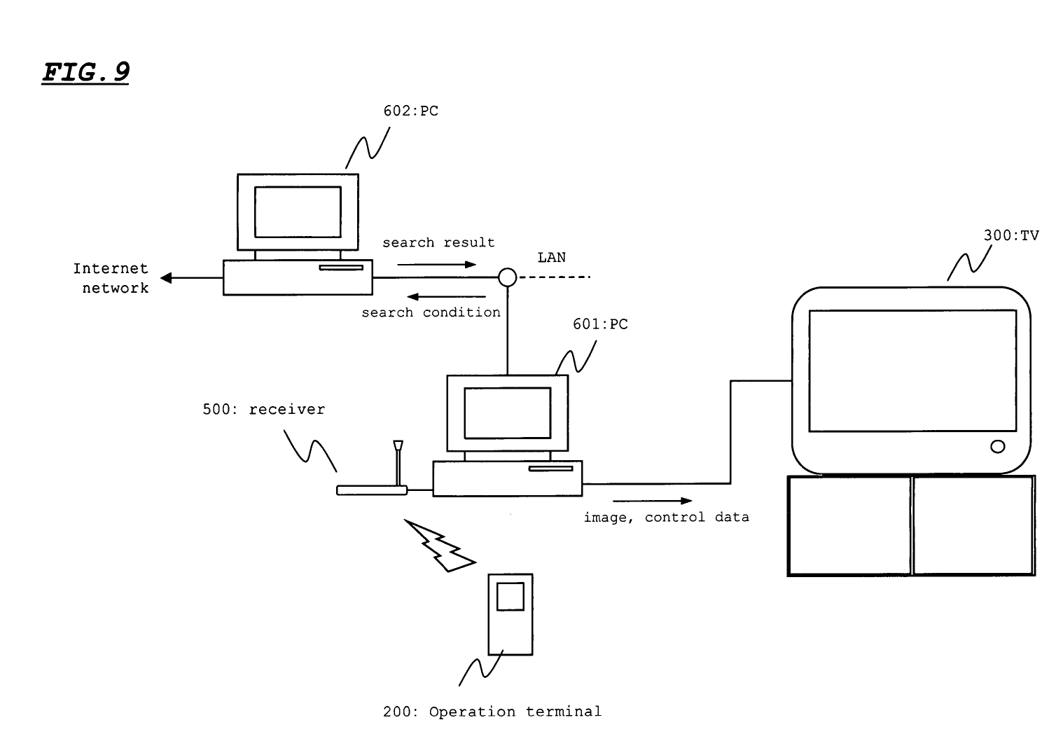

An example of using a general-purpose computer to build the controller 100 is shown in FIG. 9, where the above-described functions of the controller 100 are divided between two PCs (personal computers) 601 and 602 connected to each other by a LAN. In the case of FIG. 9, of the function blocks of FIG. 2, the PC 602 bears the functions of the search unit 111 and the control item search DB 112 whereas the PC 601 bears the rest of the functions. In other words, the PC 601 creates a search condition from the result of voice recognition processing and sends the created search condition to the PC 602. Receiving the search condition, the PC 602 uses the search condition to execute a search and sends the result of the search to the PC 601. When the functions of the controller 100 are installed in a PC or PCs, it is necessary to add a receiver 500 for receiving signals from the operation terminal 200 to the remote control system as shown in FIG. 9.

In the above description, the appliance to be controlled is the television set 300. Appliances other than a television set may be controlled by the control system. The control system may further be developed to control, in a centralized manner, plural appliances connected by a LAN as in a home network.

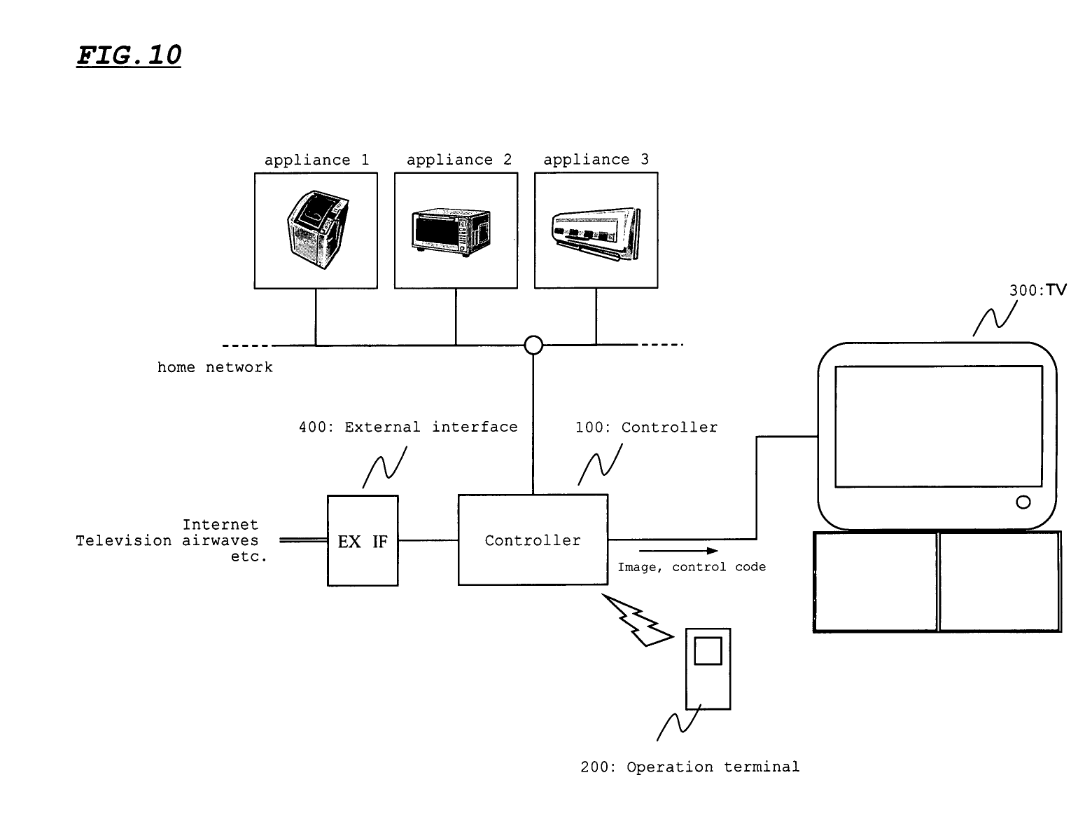

FIG. 10 shows a system configuration example for controlling plural appliances that are connected to a home network in a centralized manner. In this case, of the function blocks of FIG. 2, the voice recognition dictionary 108 and the control item search DB 112 have to be modified to adapt to the plural appliances. Specifically, voice recognition dictionary 108 has to have dictionary information for each appliance connected to the home network and the control item search DB 112 has to have control item databases (corresponding to those in FIGS. 3 and 4) for each appliance connected to the home network.

When the operation terminal 200 of this system receives an audio input, a recognition dictionary, where voice recognition dictionaries for the respective appliances are merged, is set. The set recognition dictionary is used by the voice recognizing unit 107 to execute voice recognition processing. The search condition creating unit 110 creates a search condition from the results of the voice recognition. The search condition is used by the search unit 111 to conduct a search in which recognition results (Keyword 11, Keyword 12 . . . shown in FIG. 7) included in the search condition are compared against the control item databases built for the respective appliances in the control item search DB 112, to thereby count matching counts in the manner described above. Then the output information creating unit 113 arranges control items in a descending order by the matching count, and the control items are displayed in this order on the display screen.

When the pointing device 201 or the operation keys 203 are operated instead of audio inputting, the control system operates mostly the same way as described above. To elaborate, a control item pointed by the pointing device 201 is highlighted or displayed enlarged. The “select key” of the operation keys 203 is operated while the desired control item is pointed, to thereby obtain control codes (Code 1, Code 2 . . . ) of this control item. The obtained control codes are sent to the corresponding appliance.

Specifying an appliance to be controlled is made possible by displaying information for identifying the target appliance (e.g., an air conditioner in a Japanese style room, an air conditioner in a living room) along with a control item displayed on the television screen.

The target appliance identification information can be displayed by modifying the function blocks shown in FIG. 2 as follows:

An appliance database for managing appliances on the home network is separately prepared, and each appliance registered in this database is associated with the control item DB built for each appliance in the control item search DB 112. Specifically, a control item DB is prepared for each “appliance type” in the control item search DB 112, and appliance type information (product code or the like) is attached to each control item DB. In this way, appliances in the appliance database are associated with control item DBs through appliance type information (product code or the like).

The appliance database holds appliance type information (product code or the like) for each registered appliance. The appliance database also holds appliance identification information (appliance ID, appliance type, installation location and the like).

After extracting control items using the search condition, the search unit 111 obtains, from the control item search DB 112, appliance type information of control item DBs containing the extracted control items. The search unit 111 then consults the appliance database to specify an appliance that corresponds to the obtained appliance type information (in the case where plural appliances of the same appliance type are connected to the home network, every one of the appliances is chosen), and obtains identification information (e.g., appliance ID, appliance type=air conditioner, installation location=Japanese style room) of the specified appliance from the appliance database.

The thus obtained appliance identification information is sent to the output information creating unit 113 along with the extracted control items. In the case where identification information of plural appliances is obtained for one control item, identification information of each of the appliances is separately paired with the control item and outputted to the output information creating unit 113.

Receiving the information, the output information creating unit 113 creates display information such as the title or the like of the received control item, and the appliance type, location information, and other information contained in the received appliance identification information, which are included in items to be displayed. In this way, information for identifying a control target appliance (e.g., the air conditioner in the Japanese style room, the air conditioner in the living room) is displayed along with a control item on the television screen. The output information creating unit 113 simultaneously sends, to the pointed target determining unit 103, association information that associates the control item displayed on the display screen, the control item's display area, and an appliance ID of identification information paired with this control item with one another.

When one of items displayed on the television screen is chosen by the user, a control item and an appliance ID that are associated with the displayed item are outputted from the pointed target determining unit 103 through the operation processing unit 105 to the control code issuing unit 106. Receiving the control item and the appliance ID, the control code issuing unit 106 obtains control codes (Code 1, Code 2 . . . ) for this control item, and checks the appliance ID against the appliance database to specify an appliance to which the obtained control codes are sent. Then the control code issuing unit 106 outputs the obtained control codes to the specified appliance. A function the user desires is thus set in this appliance.

In a search conducted by the search unit 111, the suitability of a control item may be judged from the current operation status of each appliance to remove unsuitable control items from options. In this case, the search unit 111 uses, as described above, appliance information (product code or the like) to specify appliances that are associated with control item extracted from the results of voice recognition. The search unit 111 then detects the current operation status of the specified appliances to judge, from the detected current operation status, whether control according to the extracted control items is appropriate or not. Control items that are judged as appropriate are included in candidates to choose from whereas control items that are judged as inappropriate are excluded from the candidates.

One way to enable the search unit 111 to perform the processing of judging the suitability of a control item from the current operation status, is to give the search unit 111 a table that associates a control item with the operation status of a corresponding appliance to consult.

When appliances on a network are to be controlled in a centralized manner as described above, a voice recognition dictionary and a control item DB have to be prepared for each of the appliances. This poses a problem in the case where a voice recognizing unit, voice recognition dictionaries, a search unit, and a search DB are integrated in a controller, since voice recognition dictionaries and control item DBs have to be built in advance based on a speculation about what appliances will be connected to the network and it makes the voice recognition dictionaries and the control item DBs considerably large in size as well as cost. Another problem is that modifying such voice recognition dictionaries and control item DBs is difficult and therefore an appliance that is newly put on the market cannot easily be added to the network.

These problems can be solved by giving the functions of the voice recognizing unit, the voice recognition dictionaries, the search unit, and the search DB to an external server that is connected to the Internet or the like.

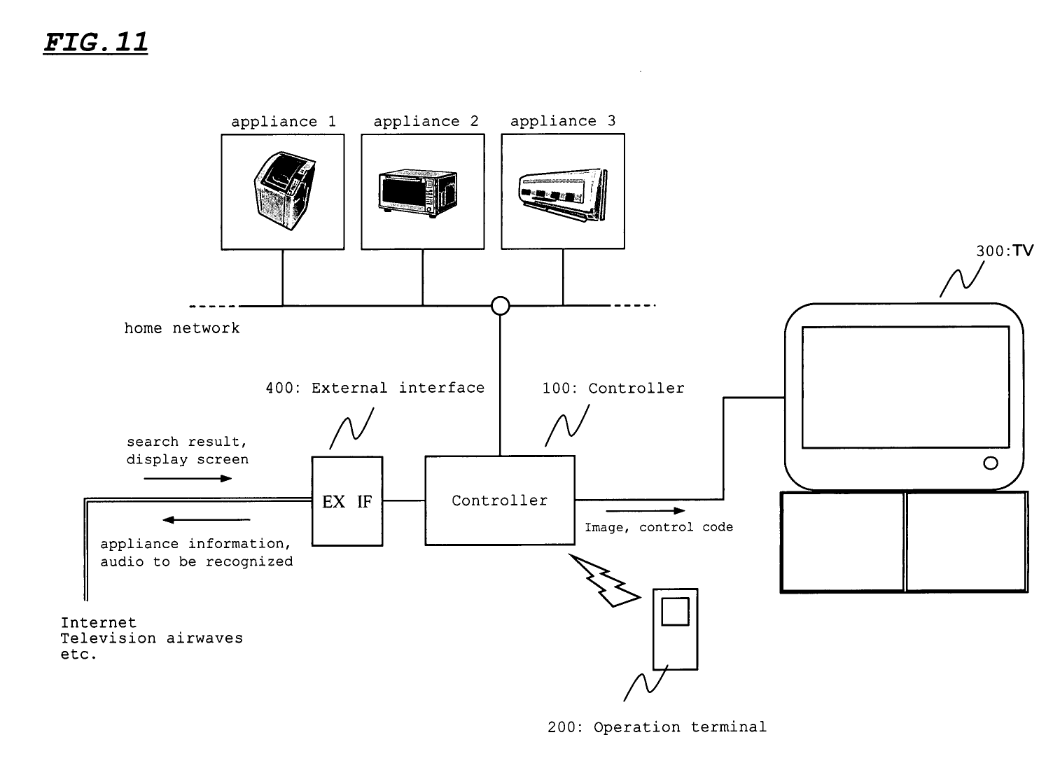

A system configuration example for this case is shown in FIG. 11. In the configuration example of FIG. 11, when a voice is inputted through the operation terminal 200, the controller 100 sends, to the external server, audio information and appliance information for identifying an appliance connected to the home network. Receiving the information, the external server performs voice recognition processing on the audio information and searches control items associated with the results of the voice recognition. The search results are sent to the controller 100.

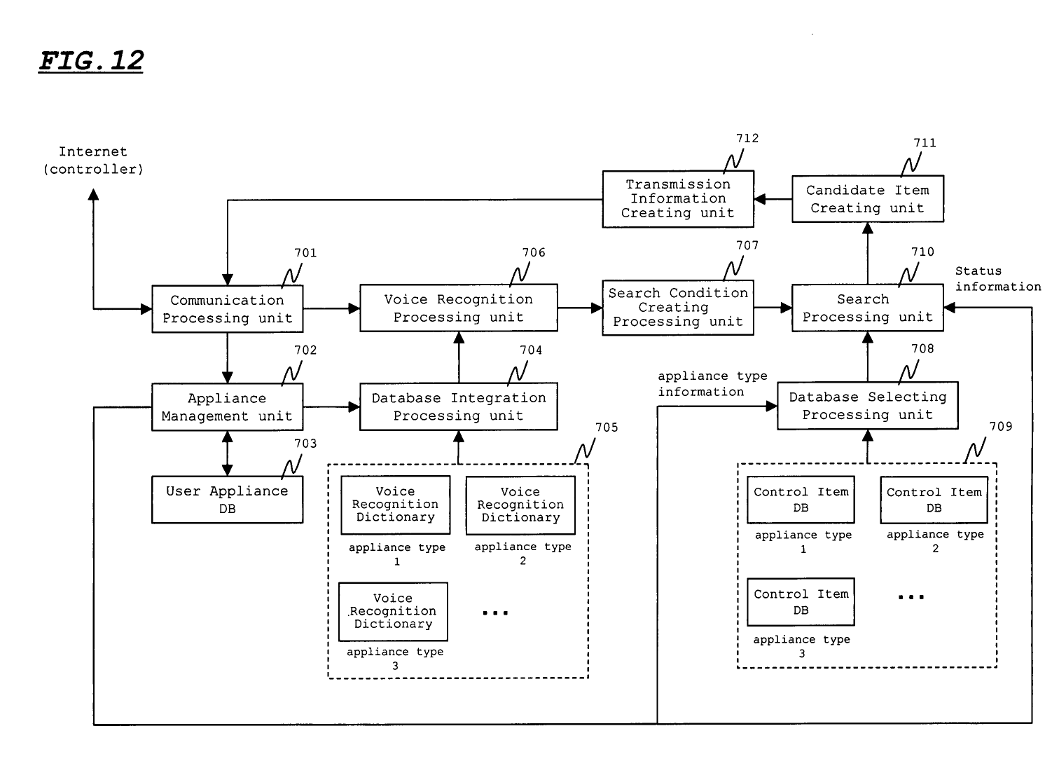

FIG. 12 is a diagram showing the configuration of the external server that has the functions of the voice recognizing unit, the voice recognition dictionaries, the search unit, and the search DB. In FIG. 12, a communication processing unit 701 processes communications over the Internet. An appliance management unit 702 manages appliances registered by a user. A user appliance DB 703 is a database for storing appliance information (appliance IDs, appliance type information and the like) of the registered appliances.

A database integration processing unit 704 uses appliance type information inputted from the appliance management unit 702 to merge pieces of dictionary information stored in a voice recognition dictionary DB 705. The voice recognition dictionary DB 705 is a database in which voice recognition dictionaries are stored for each appliance type. A voice recognition processing unit 706 uses a voice recognition dictionary obtained by merging the database integration processing unit 704 to perform voice recognition processing on audio information inputted from the communication processing unit 701. A search condition creating processing unit 707 creates a search condition from recognition results (keywords) inputted from the voice recognition processing unit 706.

A database selecting processing unit 708 uses appliance type information inputted from the appliance management unit 702 to select a control item database stored in a control item search DB 709. The control item search DB 709 is a database in which a control item database is stored for each appliance type.

A search processing unit 708 uses a search condition inputted from the search condition creating processing unit 707 to execute search processing. In the search processing, control items in a control item database chosen by the database selecting processing unit 708 are compared against keywords contained in the search condition to count matching counts, and control items are extracted as options in a descending order by their matching counts. For details of this search processing, see the above description that has been given with reference to FIG. 7. The search processing unit 710 then checks control according to the extracted control items against appliance status information inputted from the appliance management unit 702 to remove control items that do not agree with the appliance status from the options. Control items that remain after the screening are outputted to a candidate item creating unit 711.

The candidate item creating unit 711 obtains, from the appliance management unit 702, appliance IDs associated with the inputted control items, and creates a candidate item group by pairing the appliance IDs with the control items. A transmission information creating unit 712 creates transmission information for sending the candidate item group to the controller of the user concerned. The created transmission information is outputted to the communication processing unit 701.

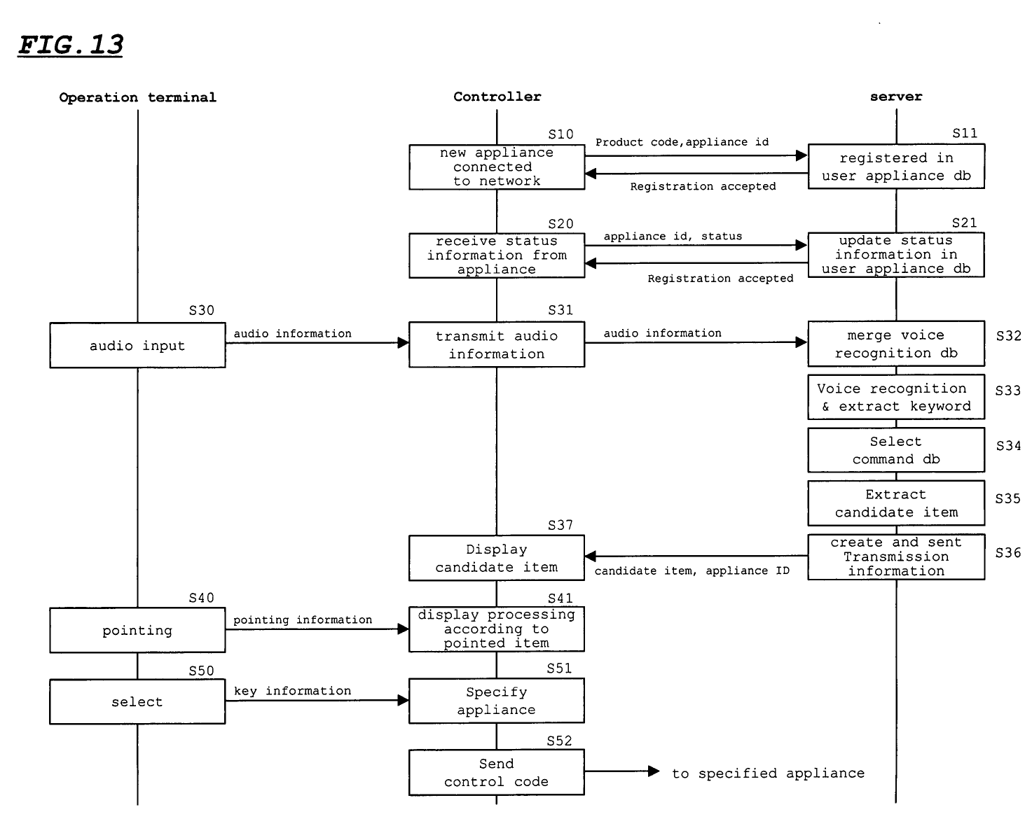

FIG. 13 shows a processing flow of this system.

When a new appliance is connected to the home system of the user, the controller 100 registers appliance type information (control code or the like) and appliance identification information (appliance ID, appliance type, installation location and the like) of the added appliance in the appliance database. Thereafter, the controller 100 sends the appliance type information and appliance ID of this appliance to the external server (step S10). The external server checks the received information and, when the received information is judged to have been sent from an authentic user, registers the information in the user appliance DB 703 (step S11).

When status information is received from an appliance on the home network, the controller 100 stores the received status information in the appliance database, and sends the received status information along with the appliance ID of this appliance to the external server (step S20). The external server checks the received information and, when the information is judged as one sent from an authentic user to an authentic appliance, registers the information in the user appliance DB 703 (step S21).

When a voice is inputted through the operation terminal 200, the operation terminal 200 sends audio information about this audio input to the controller 100 (step S30). Receiving the audio information, the controller 100 creates a search request information containing the audio information and sends the created search request information to the external server (step S31).

Receiving the information, the external server first obtains, from the user appliance DB 703, appliance type information of an appliance group that is registered under the name of this user. Next, the database integration processing unit 704 extracts, from the voice recognition dictionary DB, voice recognition dictionaries that correspond to the obtained appliance type information, and merges the obtained dictionaries to create a voice recognition dictionary (step S32). Using the created voice recognition dictionary, the external server performs voice recognition on the audio information received from the controller 100, and obtains recognition results (keywords) (step S33). The search condition creating processing unit 707 creates a search condition from the recognition results, and sends the created search condition to the search processing unit 710.

The external server next gives the appliance type information of the appliance group obtained by the appliance management unit 702 to the data base selecting processing unit 708, which selects and sets a control item database group that is associated with this appliance type information as databases to be consulted during a search (step S34). The search processing unit 710 uses the selected and set control item database group and the search condition provided by the search condition creating processing unit 707 to extract a candidate item group (step S35). Appliance IDs that are associated with the extracted control items are obtained from the appliance management unit 702, and paired with the control items to create a candidate item group. The transmission information creating unit 712 uses the created candidate item group to create transmission information, which is for sending the candidate item group to the controller of the user concerned. The created transmission information is sent to the controller 100 via the communication processing unit 701 (step S36).

The controller 100 obtains the control items and the appliance IDs from the received candidate item group, and uses the received appliance IDs to obtain, from the appliance database, appliance types and installation locations of the appliances that are identified by the appliance IDs. Then, the control items and the appliance types and installation locations of these appliances are simultaneously displayed as displayed items on the television screen (step S37).

When the operation terminal 200 is operated as a pointing device while the displayed items are on the screen (step S40), the controller 100 makes the control item that is pointed with the pointing device highlighted or enlarged on the screen (step S41). The “select” key of the operation terminal 200 is operated in this state (step S50). Subsequently, in the manner described above, an appliance that is associated with the pointed control item is specified first (step S51) and then control codes of this control item are obtained and transmitted to the appliance specified in step S51 (step S52). Thus, a control function the user desires is set in this appliance.

As has been described, according to this embodiment, the controller can have a simple configuration and the cost can be reduced by having the external server perform voice recognition processing and processing of narrowing down options. In addition, the external server can adapt to a new appliance put on the market by adding a recognition dictionary and control item database of the new appliance to the databases in the external server, and thus ensures that an addition of a new appliance to the home network does not impairs smooth control operation.

Furthermore, this embodiment makes it possible to build a new business using the external server, and enables a user to control an appliance in the house of another user by registering operation authority in the external server. Thus, according to this embodiment, the control operation is made smoother and business fields or service forms can be expanded.

### Second Embodiment

In the above embodiment, a control item group according to results of voice recognition of an audio input is displayed as candidates from which a user chooses and designates a desired control item, and control codes associated with this control item are issued to the television set 300. In contrast, in a second embodiment of the present invention, what is displayed first as options on the display screen when there is an audio input are results of voice recognition and a group of synonyms of the voice recognition results. After a user chooses a desired item from the displayed options, a group of control items associated with the chosen item is displayed as candidate control items. The user chooses and designates a desired control item from this control item group, and control codes of this control item are issued to the television set 300.

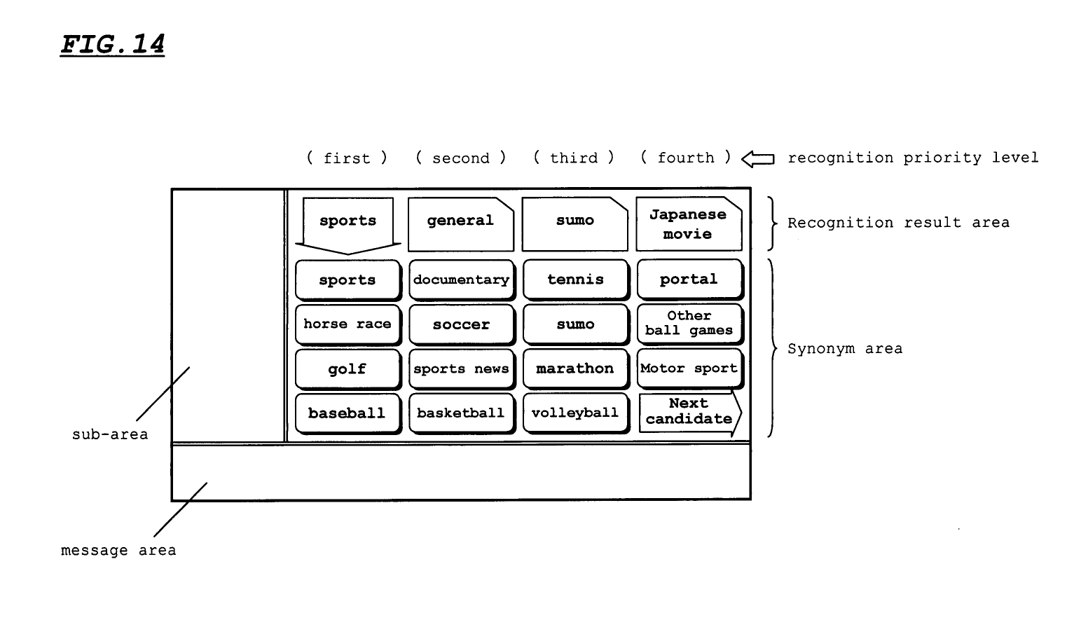

FIG. 14 is a diagram illustrating the display screen of when an audio input is received.

As shown in FIG. 14, when a voice is inputted, recognition results and their synonyms are displayed as options on the display screen (a main area). In the example of FIG. 14, synonyms of the top recognition result (sports) are displayed in a synonym area. Displayed in the synonym area as synonyms of a recognition result are an item word that is associated with the recognition result, a normalized expression, a hypernym, and a hyponym (details will be described later).

When one of the second or subsequent recognition results are chosen and designated in this state, synonyms of the designated recognition result are displayed in the synonym area. If the number of synonyms ranging from the top recognition result to the recognition result at a given recognition priority level is low enough, all the synonyms may be displayed in the synonym area at once.

When one of the synonyms displayed in the synonym area is chosen and designated in this state, control items associated with the chosen synonym are searched and displayed as candidates. The search condition created for this search includes not only the chosen synonym but also a normalized expression of the synonym. Therefore, a slightly larger control item group than in the above embodiment is presented to the user.

Other than this function, the second embodiment has more additional functions to improve the user friendliness of operation. The additional functions will be described separately when the topic arises in the following description.

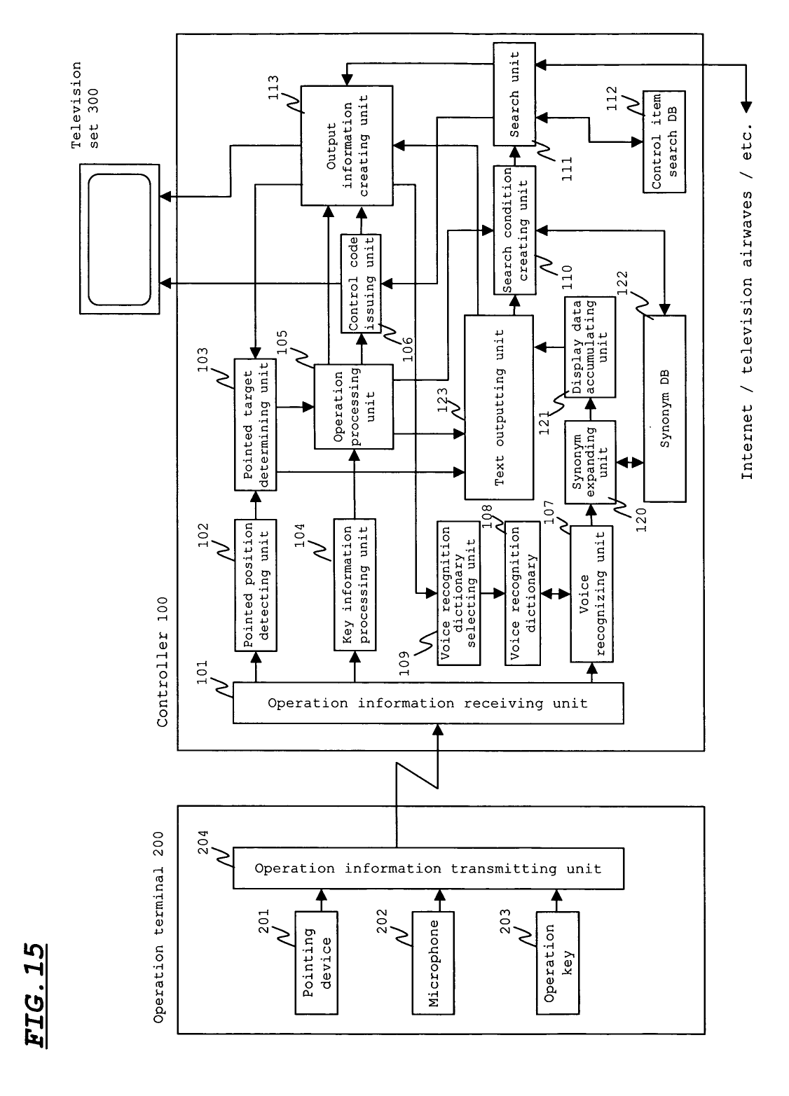

FIG. 15 is a function block diagram of the controller 100 and the operation terminal 200 according to this embodiment.

In the controller 100 according to this embodiment, the functions of the pointed target determining unit 103, the operation processing unit 105, the search condition creating unit 110 and the output information creating unit 113 differ from those of the above embodiment. Another difference from the above embodiment is that a synonym expanding unit 120, a display data accumulating unit 121, a synonym DB (database) 122 and a text outputting unit 123 are added.

The pointed target determining unit 103 uses pointed position information received from the pointed position detecting unit 102 to judge which item on the screen is designated. When the designated item is an item in the synonym area or recognition result area shown in FIG. 14, the pointed target determining unit 103 outputs the item determined as the designated item to the text outputting unit 123. When the designated item is determined as none of the items in the synonym area or the recognition result area, the pointed target determining unit 103 outputs the designated item to the operation processing unit 105.

As in the above embodiment, when the same target is kept pointed for a given period of time or longer, the operation processing unit 105 uses the output information creating unit 113 to emphasize the designated item (by highlighting, enlarging or the like) on the display screen. When information indicating to press down on the select key is received from the key information processing unit 104 while a control item group is displayed, the operation processing unit 105 causes the control code issuing unit 106 to output control codes that are associated with the designated control item. At the same time, the operation processing unit 105 causes the output information creating unit 113 to output an assist operation screen according to the issued control codes. For instance, in the case where a control code for switching the sound is issued, the operation processing unit 105 has the output information creating unit 113 output a screen displaying buttons to select from the primary sound, the secondary sound, and the primary sound+the secondary sound. Processing related to the assist operation screen will be described later in detail.

The operation processing unit 105 also uses the information received from the key information processing unit 104 to judge whether or not further narrowing down of displayed items is possible. In the case where further narrowing down is possible, the operation processing unit 105 instructs the search condition creating unit 110 or the text outputting unit 123 to execute the narrowing down. The operation processing unit 105 holds a table in which key operation items that can be used to narrow down displayed items are associated with categories to which the key operation items are applied. The operation processing unit 105 judges that narrowing down of displayed items is possible when inputted key operation information matches a key operation item in the table and the category associated with this key item coincides with a currently displayed key item group.

In the case where key operation items that can be used for narrowing down are received from the key information processing unit 104 while recognition results and synonym items are being displayed on the screen (FIG. 14), the operation processing unit 105 instructs the text outputting unit 123 to further narrow down synonym items to be displayed. In the case where key operation items that can be used for narrowing down are received from the key information processing unit 104 while control items are being displayed on the screen, the operation processing unit 105 instructs the search condition creating unit 110 to create and output a search condition for further narrowing down control items to be displayed. The processing for when further narrowing down is possible will be described later in detail.

The search condition creating unit 110 creates a search condition from information (item words, normalized expressions) received from the text outputting unit 123 and key operation items received from the operation processing unit 105. The created search condition is outputted to the search unit 111. Details of processing of the search condition creating unit 110 will be described later.

The output information creating unit 113 has, in addition to the functions described in the above embodiment, a function of creating layout information (FIG. 14) of an output screen from voice recognition results and synonyms received from the text outputting unit 123, and outputting the created layout information to the television set 300. Another function of this output information creating unit 113 is to create association information that associates items contained in the layout information with areas where the items are displayed, and to output the created association information to the pointed target determining unit 103.

The synonym expanding unit 120 extracts, from the synonym DB 122, synonyms associated with each recognition result (item word, normalized expression, hypernym, and hyponym) based on upper N voice recognition results (N best) received from the voice recognizing unit 107, and outputs the extracted synonyms to the display data accumulating unit 121. The display data accumulating unit 121 stores the synonyms of the N best inputted from the synonym expanding unit 120, and outputs the synonyms to the text outputting unit 123.

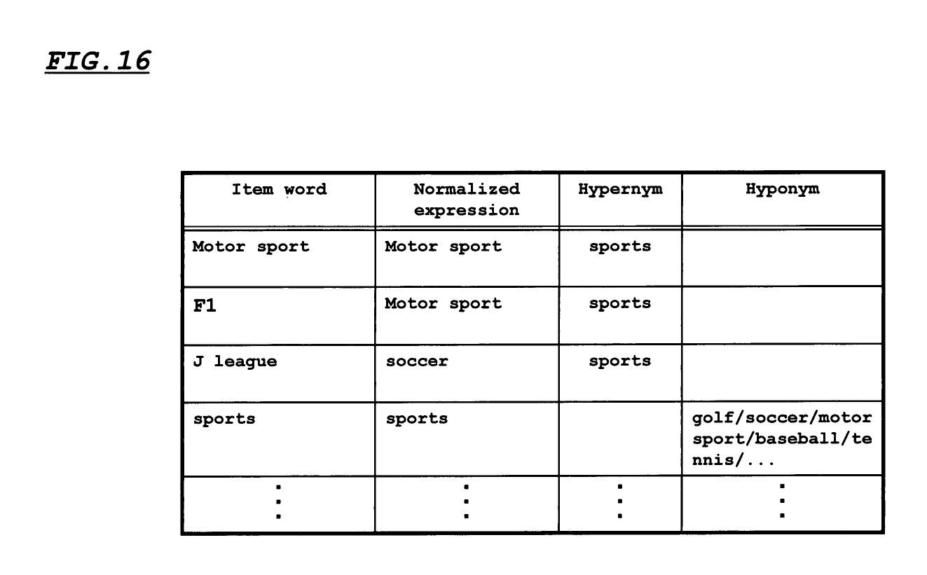

The synonym DB 122 has a configuration shown in FIG. 16 to store synonym information. As shown in FIG. 16, synonym information is composed of an item word, a normalized expression, a hypernym, and a hyponym.

An item word is an index word checked against a voice recognition result when synonyms for the voice recognition result are searched. A normalized expression is an inclusive, conceptual expression of an item word. A hypernym expresses an item word in an upper category. A hyponym is a lower meaning contained in a category determined by an item word.

All terms that are classified as normalized expressions, hypernyms, and hyponyms are stored also as item words in the synonym DB 122. In the example of FIG. 16, “golf”, “soccer”, “motor sports”, “baseball”, “tennis” . . . which are hyponyms of an item word “sports” are stored also as item words in the synonym DB 122 and, in association with these item words, their normalized expressions, hypernyms, and hyponyms (if there is any) are stored in the synonym DB 122.

The synonym expanding unit 120 described above compares the upper N voice recognition results (N best) received from the voice recognizing unit 107 against the item words in the synonym DB 122 to extract, for each of the voice recognition results, an item word that completely matches the voice recognition result, as well as the normalized expression, hypernym and hyponym of this item word. The extracted synonym information and the voice recognition results are outputted to the display data accumulating unit 121. The display data accumulating unit 121 stores the synonym information and voice recognition results received from the synonym expanding unit 120, and outputs the information and the results to the text outputting unit 123.

Receiving the synonym information (item words, normalized expressions, hypernyms, and hyponyms) of the N best from the display data accumulating unit 121, the text outputting unit 123 outputs this synonym information to the output information creating unit 113, and instructs the output information creating unit 113 to create the display screen shown in FIG. 14 from the synonym information.

When an item pointed on the display screen is judged as an item word in the synonym DB 122 by the pointed target determining unit 103, the text outputting unit 123 instructs the search condition creating unit 110 to create and output a search condition that includes this item word and the normalized expression of the item.

When an item pointed on the display screen is judged as an item displayed in the recognition result area of FIG. 14 by the pointed target determining unit 103, the text outputting unit 123 instructs the output information creating unit 113 to display synonyms corresponding to the designated voice recognition result and the N best in the synonym area and in the recognition result area, respectively.

When pointed by the operation processing unit 105 to narrow down displayed items with the use of key operation items as described above while recognition results and synonyms are displayed on the display screen (FIG. 14), the text outputting unit 123 uses the key operation items to narrow down synonym information (item words, normalized expressions, hypernyms, and hyponyms) in the display data accumulating unit 121. The text outputting unit 123 outputs the narrowed down synonym information to the output information creating unit 113, and instructs the output information creating unit 113 to display a display screen that contains the narrowed down synonyms.

The narrowing down is achieved by, for example, conducting a text search on synonym information (item words, normalized expressions, hypernyms, and hyponyms) in the display data accumulating unit 121 using the key operation items as keywords. To elaborate, synonyms that contain the key operation items as text are extracted out of the synonyms stored in the display data accumulating unit 121. Alternatively, the narrowing down is achieved by storing, in the synonym DB 122, attribute information of each term along with synonyms and extracting synonyms that have attribute information corresponding to the key operation items.

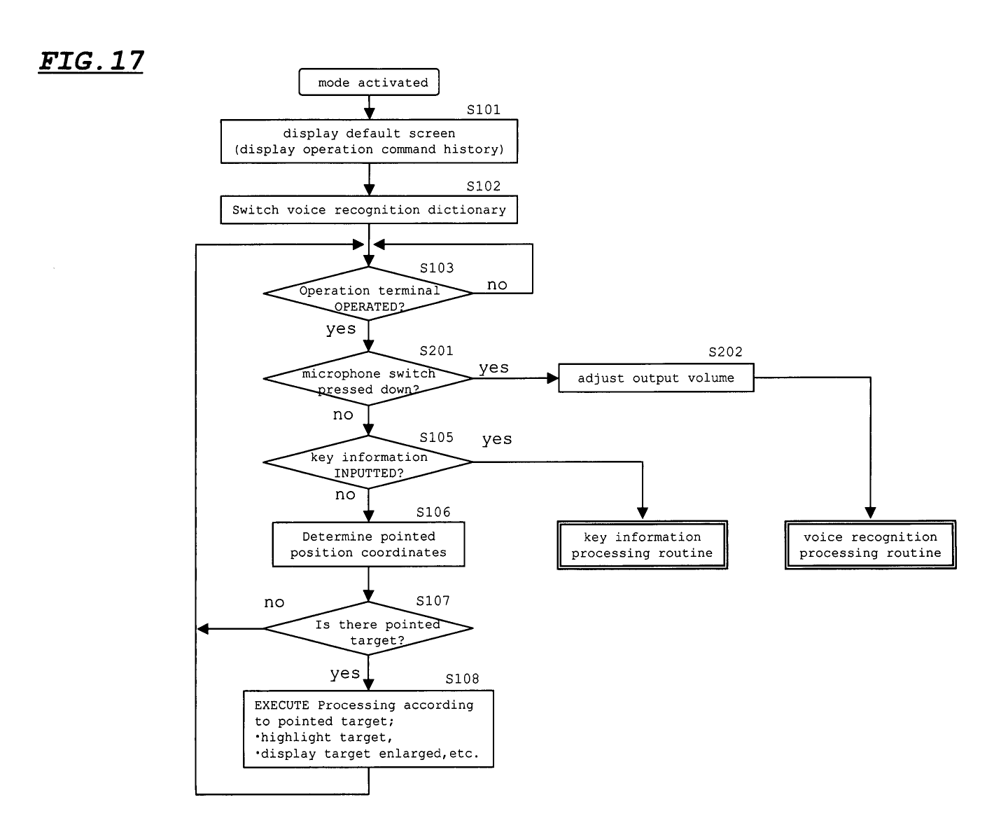

Now, a description is given with reference to FIGS. 17 to 22 on how this control system operates. The part that is identical with the processing step described in the above embodiment with reference to FIG. 6 is denoted by the same reference symbol.

As a control mode is activated, first, the output information creating unit 113 causes the television screen to display a default screen (step S101). On the default screen in this embodiment, an operation history going back to several previous operations is displayed in a sub-area of FIG. 14. The subsequent processing steps S102 to S108 are executed similarly to the steps in the above embodiment. In this embodiment, however, step S104 of FIG. 6 is replaced with step S201.

The operation terminal 200 of this embodiment has a microphone switch. While the microphone switch is pressed down, or for a given period after pressing down on the microphone switch, sound information is transmitted from the microphone 202. In step S201, whether the microphone switch has been pressed down by the user or not is judged.

In the case where the microphone switch is placed among the operation keys 203, key information indicating that the microphone switch has been pressed down is transmitted from the operation terminal 200 to the controller 100. In this case, the judgment in step S201 is made by the operation processing unit 105.

In the case where the microphone switch serves as an activation switch of the microphone 202, sound information is transmitted from the operation information transmitting unit 204 to the operation information receiving unit 101 as the microphone switch is pressed down. In this case, a function unit for determining whether sound information has been received or not is added to the configuration of FIG. 15. The judgment in step S201 is made by the function unit.

When it is detected in step S201 that the microphone switch has been pressed down, the output volume of the television set 300 is adjusted in step S202. In other words, when the current output volume of the television set 300 exceeds a threshold level, a control code for lowering the output volume to the threshold level or lower is outputted to the television set. This is to prevent the microphone 202 to catch sounds of the television set 300 as noise. As a result, a voice inputted by the user can be processed by recognition processing without difficulties.

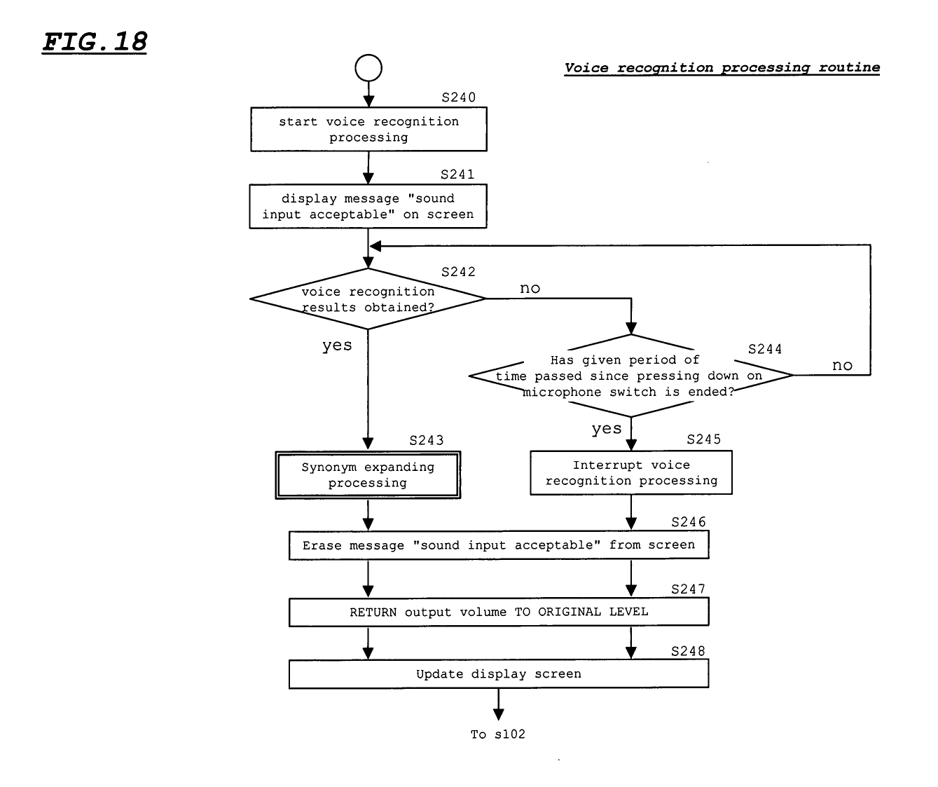

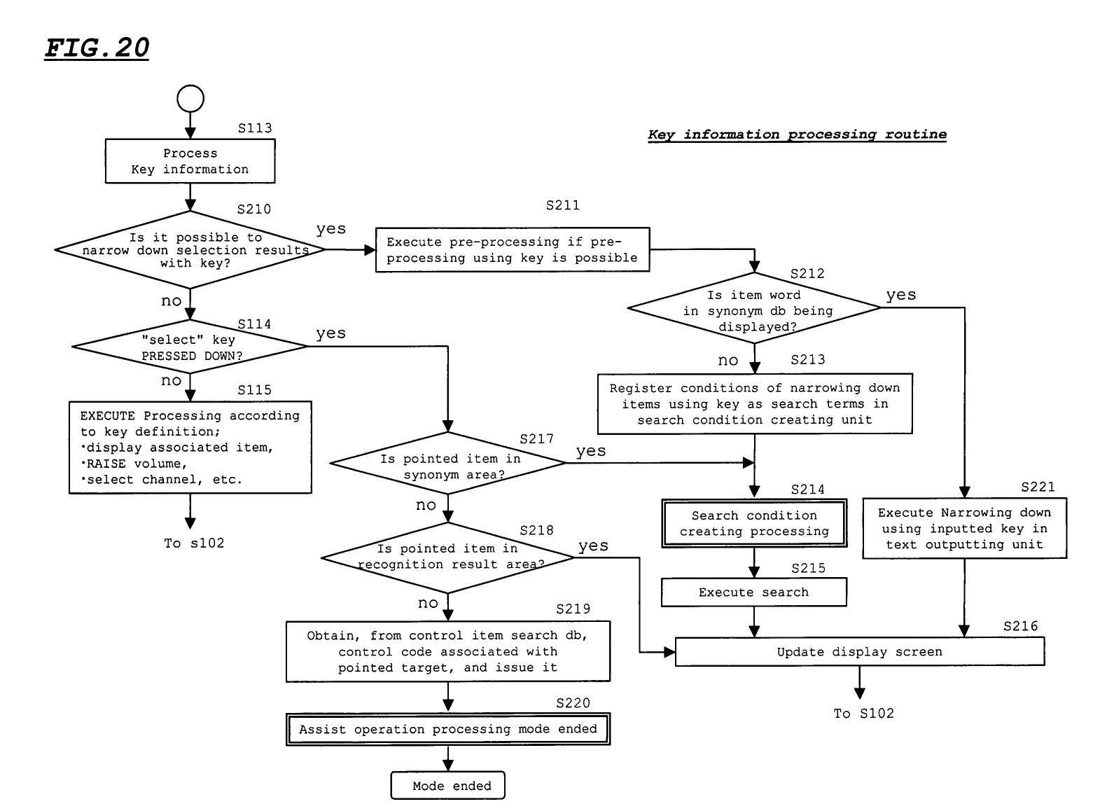

After the output volume of the television set 300 is adjusted in this manner, the processing flow moves to a voice recognition routine (FIG. 18). In the case where the operation keys 203 are operated and a key input is received, the processing flow moves to a key information processing routine (FIG. 20). In the case where the pointing device 201 is operated, the processing steps from step S106 are carried out. The processing steps from step S106 are the same as the processing described in the above embodiment with reference to FIG. 6.

FIG. 18 shows the voice recognition routine.

As the processing flow moves from step S202 of FIG. 17 onto the voice recognition routine, voice recognition processing is started (step S240) and a message “sound input acceptable” is displayed on the screen of the television set 300 (step S241). In the case where the judgment in step S201 (FIG. 17) is made by the operation processing unit 105, the message is displayed in accordance with an instruction given from the operation processing unit 105 to the output information creating unit 113.

Thereafter, when voice recognition results are provided by the voice recognizing unit 107, the synonym expanding unit 120 performs synonym expanding processing (step S243). In the synonym expanding processing, the upper N voice recognition results (N best) are compared against the item words in the synonym DB 122 to extract, for each of the voice recognition results, an item word that completely matches the voice recognition results, as well as the normalized expression, hypernym and hyponym of this item word. The extracted synonym information is outputted to the display data accumulating unit 121.

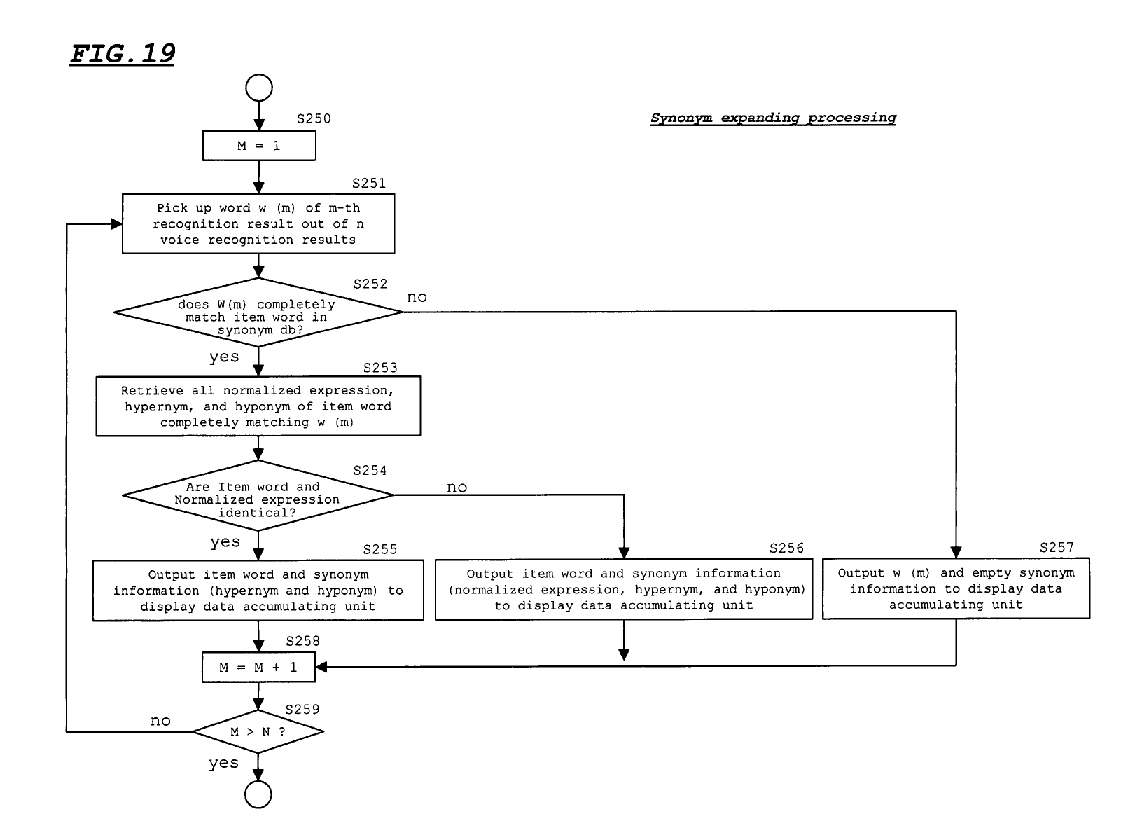

FIG. 19 shows a processing flow in step S243.

As the processing is started, 1 is set to a variable M (step S250), and a word W (M), which is the M-th voice recognition result in the recognition priority order, is extracted from the N voice recognition results (step S251). Next, the synonym information groups in the synonym DB 122 are searched for an item word that completely matches W (M) (step S252). If there is an item word that completely matches W (M) (step S252: yes), the normalized expression, hypernym, and hyponym corresponding to this item word are all extracted from the synonym DB 122 (step S253). Then it is judged whether the extracted item word is the same as its normalized expression (step S254) If the extracted item word and its normalized expression are judged as the same, the item word and its hypernym and hyponym are outputted to the display data accumulating unit 121 (step S255). On the other hand, if the extracted item word and its normalized expression are judged as different (step S254: no), the item word and its normalized expression, hypernym and hyponym are outputted to the display data accumulating unit 121 (step S255).

When it is judged in step S252 that there is no item word in the synonym DB 122 that completely matches W (M), W (M) and empty synonym information are outputted to the display data accumulating unit 121 (step S257).

As the processing on W (M) is thus finished, 1 is added to the variable M and the process flow returns to step S251 to process the next recognition result in the recognition priority order in the same manner. This processing is repeated until the N-th recognition result in the recognition priority order is processed (step S259). In this way, synonym information for the N best is outputted to the display data accumulating unit 121.

Returning to FIG. 18, the message “sound input acceptable” that has been displayed on the display screen is erased as the synonym expanding processing in step S243 is finished in the manner described above. Then the output volume of the television set 300 is returned to the state before the adjustment in step S202 (FIG. 17) (step S247). The synonym information and voice recognition results received from the display data accumulating unit 121 are outputted by the text outputting unit 123 to the output information creating unit 113, which then outputs, to the television set 300, information for displaying a screen as the one shown in FIG. 14. This updates the display screen of the television set 300 to display a screen as the one shown in FIG. 14 (step S248).

In the case where the voice recognition results are not obtained in step S242, it is judged in step S244 whether or not the microphone switch is no longer pressed down and whether or not a given period of time has passed since the microphone switch has returned to an unpressed state. When the result of step S244 is “no”, the wait for reception of the voice recognition results is continued (step S242). When the result of step S244 is “yes”, the voice recognition processing is interrupted (step S245), the message “sound input acceptable” that has been displayed on the display screen is erased, and the output volume of the television set 300 is returned to the state before the adjustment in step S202 (FIG. 17) (step S247). Then the display screen is returned to the state after the default screen is displayed (step S248).

Here, the voice recognition processing is continued until a given period of time elapses after the microphone switch is returned to an unpressed state (step S242). Alternatively, the voice recognition processing may be continued only while the microphone switch is pressed down.

In the case where the voice recognition results are not obtained, a message “failed to obtain voice recognition results” may be displayed in step S248 before the display screen is returned to the state subsequent to the display of the default screen.

In the case where the voice recognition results are obtained but are rejected because of low scores of the voice recognition results, it is judged in step S242 that the voice recognition results are yet to be obtained. Then, it is preferable to immediately display the message “failed to obtain voice recognition results” and prompt the user to input an audio input again. A situation in which the system shows no reaction to an audio input is thus avoided and the user-friendliness is improved.

FIG. 20 shows the key information processing routine.

As the processing flow moves from step S105 of FIG. 17 onto the key information processing routine, the key information processing unit 104 performs key information processing (step S113), and the operation processing unit 105 judges, as described above, whether displayed items can be narrowed down with this key information (step S210). When it is judged in step S210 that displayed items can be narrowed down and pre-processing is possible with this key information, the pre-processing is executed (step S211) and the narrowing down processing of step S212 and the subsequent steps are carried out.

Pre-processing is, for example, when the inputted key information designates BS broadcasting, processing to switch the reception system of the television set 300 to a BS broadcast reception mode and other necessary processing. The pre-processing enables, when a BS broadcast television program is chosen in the subsequent selecting processing, the system to quickly output the chosen program.

After pre-processing is performed in this manner, it is judged whether or not the current display screen is one that displays recognition results and synonym item groups (FIG. 14) (step S212) If the recognition results and synonym item groups are being displayed (step S212: yes), the text outputting unit 123 uses the key information to narrow down displayed items as described above (step S221). The narrowed down recognition results and synonym information are outputted by the text outputting unit 123 to the output information creating unit 113, and the display screen now displays only items that are relevant to the key information inputted (step S216).

On the other hand, if it is judged in step S212 that the current display screen is not the one that displays recognition results and synonym item groups (FIG. 14), in other words, if the current display screen is judged as one that displays control item groups (step S212: no), conditions for narrowing down items using the key information (key operation items) are registered as search terms in the search condition creating unit 110 (step S213). The search condition creating unit 110 uses the registered search terms to create a search condition (step S214). The search unit 111 uses this search condition to execute a search (step S215), and the control items that have been displayed on the display screen are narrowed down to a few items that are relevant to the key information (step S216).

When it is judged in step S114 that the select key is pressed down, whether the item selected on the display screen is in the synonym area or not is judged (step S217).

In the case where the current display screen is one that displays recognition results and synonym item groups (FIG. 14) and, of the displayed items, the designated item is in the synonym area, the answer is “yes” in step S217. In the case where the current display screen is one that displays recognition results and synonym item groups (FIG. 14) and, of the displayed items, the designated item is in the recognition result area, the answer is “no” in step S217. In the case where the current display screen is not the screen of FIG. 14, in other words, when the current display screen is one that displays control item groups, the answer is “no” in step S217. When the result of judgment in step S217 is “yes”, the process flow moves to step S214, where a search condition is created.

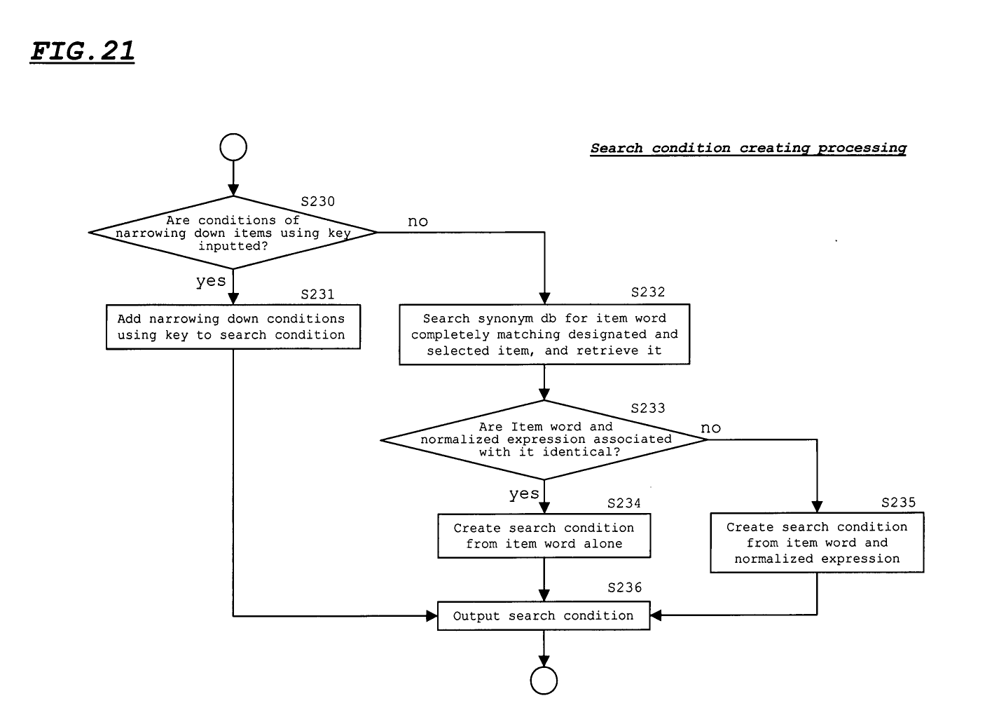

FIG. 21 shows a processing flow in step S214.

As the processing is started, whether conditions for narrowing down items using the key information are registered or not is judged in step S230. The answer is “yes” if step S214 is preceded by step S213 of FIG. 20 (while control item groups are being displayed), whereas the answer is “no” if step S214 is preceded by step S217 (while recognition results and synonym groups are being displayed).

When the answer is “yes” in step S230, the search condition creating unit 110 adds the conditions for narrowing down items using key operation items to the search condition that has been used to search control items (step S231), and outputs the new search condition to the search unit 111 (step S236). Using this search condition, the search unit 111 extracts control items further narrowed down with the key operation items than the previous search.

On the other hand, when the answer is “no” in step S230, the search condition creating unit 110 searches the synonym DB 122 for an item word that completely matches a word (any one of an item word, a normalized expression, a hypernym, and a hyponym) corresponding to the designated item (step S232). Then whether the extracted item word is the same as its normalized expression or not is judged (step S233). If the two are the same, only the item word is used for creating a search condition (step S234). If the two are not the same, the item word and its normalized expression are both included in a created search condition (step S235). The created search condition is outputted to the search unit 111 (step S236). The search unit 111 uses this search condition to extract corresponding control items from the control item search DB 112.

Returning to FIG. 20, in the case where the designated item is not in the synonym area (step S217: no), whether the designated item is in the recognition result area or not is judged (step S218). When the answer is “yes”, the operation processing unit 105 instructs the output information creating unit 113 to display a synonym group of the selected voice recognition result in the synonym area. The display screen is updated in accordance with the instruction (step S216).

On the other hand, when the answer in step S218 is “no”, in other words, when a control item in the control item group on the display screen is chosen, control codes associated with the chosen control item are retrieved from the control item search DB 112, and outputted to the television set 300 (step S219). The television set 300 is thus set in a state according to the control codes, and then assist operation processing is executed (step S220).

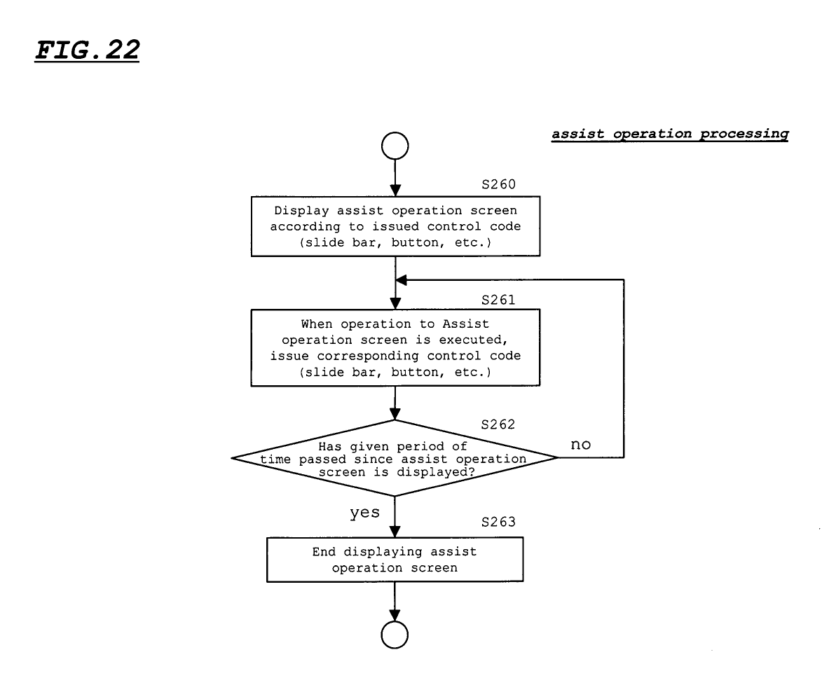

FIG. 22 shows a processing flow in step S220.

As the processing is started, the output information creating unit 113 causes the display screen to display an assist operation screen according to the control codes that are issued to the television set 300 (step S260). For instance, in the case where a control code for switching the sound is issued, the assist operation screen displays buttons to select from the primary sound, the secondary sound, and the primary sound+the secondary sound. Thereafter, the user operates the assist operation screen, causing the operation processing unit 105 to instruct the control code issuing unit 106 to issue a corresponding control code (step S261). In this way, a control code associated with the chosen function is issued to the television set 300. Then whether the assist operation screen has been displayed for a given period of time or not is judged (step S262). If the given period of time has not passed, the wait for operation on the assist operation screen is continued. If it is judged that the given period of time has elapsed, the assist operation screen stops being displayed (step S263) and the assist operation processing is ended.

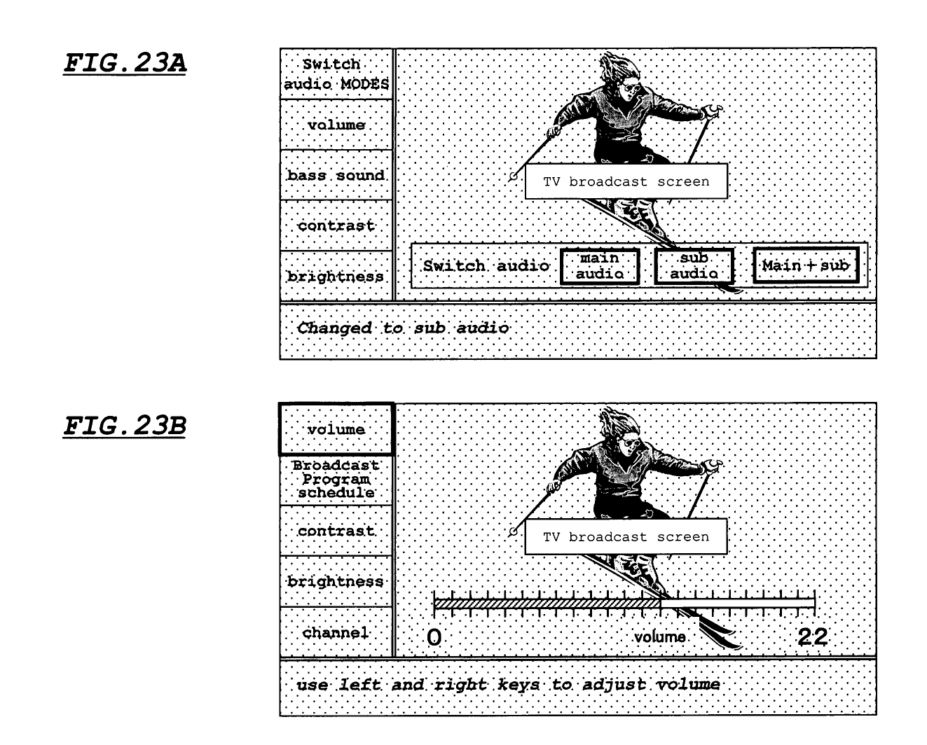

FIGS. 23A and 23B are display examples of the assist operation screen. Shown in FIG. 23A is a display example for when a control code designating the secondary sound is issued as a control code related to switching of the sound to the television set 300. The user can enter further sound switching instructions on this assist operation screen. On this assist operation screen, function items related to sound switching are displayed in the sub-area. When one of displayed function items is chosen, for example, a “volume” function item is chosen, a slide bar for changing the volume is displayed as shown in FIG. 23B. The user can adjust the volume by operating the left and right keys.

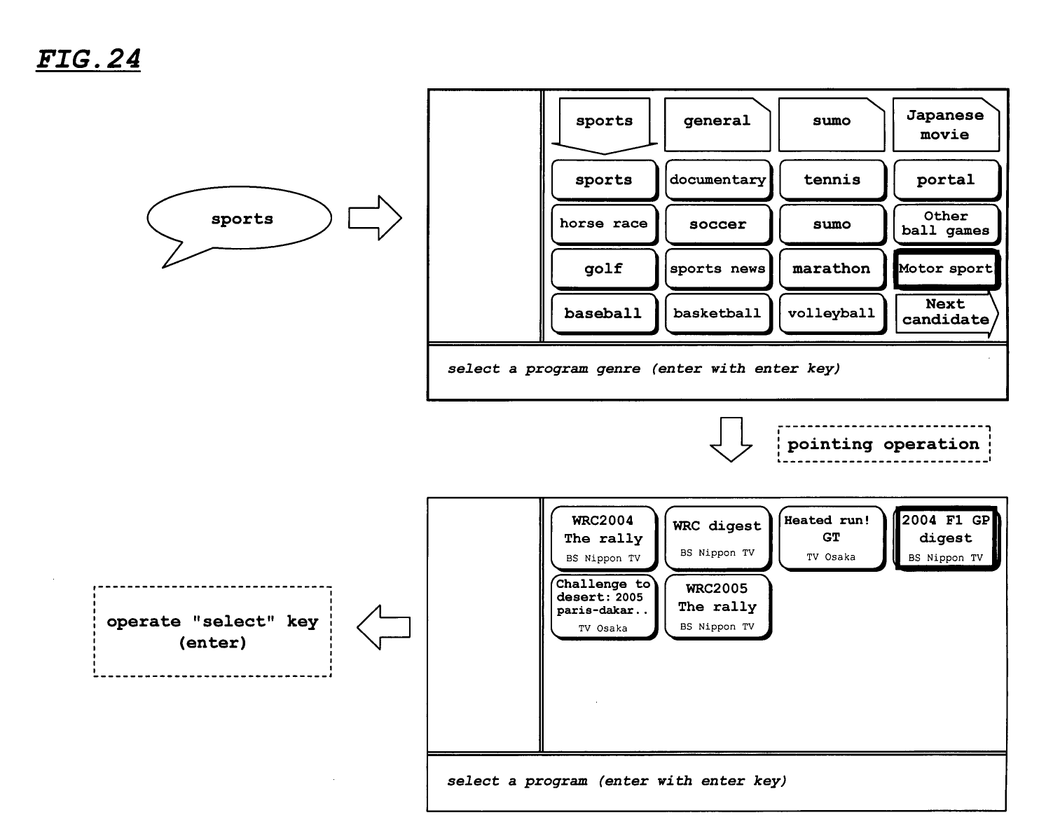

FIG. 24 shows a specific example of how this remote control system operates.

When the user presses down on the microphone switch of the operation terminal 200 and then speaks into the microphone 202 to input “sports” with his/her voice (the upper left corner of FIG. 24), the top voice recognition result to the N-th (fourth in FIG. 24) voice recognition result and a group of synonym items for the first recognition result are displayed on the television screen as described above (the upper right corner of FIG. 24).

Presented with the display, the user operates the operation terminal 200 as a pointing device to point some of control items displayed on the display screen. The control items pointed by the pointing device are sequentially highlighted (the upper right corner of FIG. 24).

If a recognition result that is not the first recognition result in the recognition priority order is chosen from among the recognition results on the top row of the screen in this state, a group of synonym items corresponding to the chosen recognition result is displayed in the synonym area on the television screen.

On the other hand, if an item is chosen from the group displayed in the synonym area in this state, an item word corresponding to the chosen item and its normalized expression are compared against terms of control items in the control item search DB 112, and control items from which one is to be chosen are displayed on the television screen (the lower right corner of FIG. 24).

Thereafter, while pointing a desired control item, the user operates the “select key” of the operation terminal 200 (the lower left corner of FIG. 24) to obtain control codes of this control item and transmit the control codes to the television set 300. A function according to this control item is thus set in the television set 300.

As has been described, according to the remote control system of this embodiment, voice recognition results and synonym groups are displayed as options to choose from upon reception of an audio input. Therefore, the user can make the system display genre/category items that are close to a desired operation by inputting any word that comes to his/her mind without fretting over what wording is appropriate for audio inputting. The user can then designates an item from the displayed genre/category items to make the system display a group of control items as options to choose from. At this point, the control item group is searched using an item word and its normalized expression and, accordingly, a slightly larger area for the control item group than in the above embodiment is presented to the user. A desired control item is therefore displayed more easily than in the above embodiment.

In the second embodiment, item words in the synonym DB 122 are all registered in the voice recognition dictionary 108. This means that all the synonyms (item words, normalized expressions, hypernyms, and hyponyms) in the synonym DB 122 are recognizable in voice recognition by the voice recognizing unit 107. For instance, if a message “items displayed after audio input can all be inputted by voice as keywords” is displayed on the default screen, the user can find out what words are acceptable for audio inputting from the screen that is displayed after an audio input (e.g., the upper half of FIG. 24). Then, from the next time, the user can directly input a desired word with his/her voice. As this operation is repeated, the user will learn what words are acceptable for audio inputting. The user thus gains more insights about what keywords are suitable for audio inputting and the range of acceptable keywords for audio inputting is increased each time the user uses this system. This system becomes more and more user-friendly as the user keeps putting this system into use.

This embodiment, too, shows the configuration of the controller 100 as function blocks. However, as in the preceding embodiment, the controller 100 may be a device dedicated to execute those functions such as a set top box, or may be a program and a database that are installed in a general-purpose computer such as a personal computer to execute those functions.

The program and the database may be stored in a memory medium such as a CD-ROM or may be obtained by data communications via the Internet or the like.

In the case of using a general-purpose computer to build the controller 100, the functions of the controller 100 may be divided between two PCs (personal computers) connected to each other by a LAN as described in the above embodiment with reference to FIG. 9.

A variety of embodiments according to the present invention have been described above, but the present invention is not limited to the above embodiments and other various modifications are possible.

For example, voice recognition which is performed by the controller in the embodiment shown in FIG. 2 may be carried out by the operation terminal 200. In this case, the operation terminal 200 sends recognition results (keywords), instead of audio information, to the controller 100. The operation terminal 200 may further be given the function of extracting items to be selected.

The operation terminal 200 in the above embodiments has a microphone, a pointing device, and operation keys all. It is also possible to divide the functions of the microphone, the pointing device, and operation keys between two or three operation terminals 200.

However, placing all operation means in one operation terminal as in the above embodiments gives superior portability and simplifies the operation. For example, the user can input a voice and designate an item from options without taking his/her eyes off the television screen. Further, if the user puts his/her finger on the “select” key in advance, the user can choose a control item without looking down at the keys. Considering this, the “select” key is preferably placed at a position where a given finger of a user's hand can easily reach while the hand is gripping the operation terminal. It is also preferable to shape the operation terminal accordingly.

In the above embodiment shown in FIGS. 12 and 13, candidate items and appliance IDs are externally sent by the external server to the controller. Along with the candidate items and the appliance IDs, screen information for displaying the candidate items on the screen may be sent by the external server. In this case, identification information (appliance type, installation location and the like) of an appliance of the user has to be registered in the user appliance DB 703 of the external server.

Voice recognition and extraction of items to be selected which are performed by the external server in the embodiment shown in FIGS. 12 and 13, may be performed by a maker server or the like at the request of the external server. In this case, the external server specifies a target appliance from the user appliance DB and sends request information containing audio information to a server of a maker that manufactures the target appliance. Alternatively, the external server may perform voice recognition and send request information containing recognition results to a server of a maker. In this case, the maker server takes up the voice recognition function and/or control item selecting function of the external server. The maker server here has a voice recognition dictionary DB and a control item search DB related to the product lineup of the maker in its database.

The pointing device in the above embodiments is composed of a gyroscope, but a joystick, a jog dial or the like may be employed instead.

The present invention is not limited to the display format shown in FIG. 8, but may include such a display format that lists up extracted control items as text information. In other words, the present invention can take any display format as long as a selection screen is presented with extracted control items, and is not particularly limited in format and order in which control items are displayed, how items are arranged, or the like.

In another employable display format, the volume of a voice (audio level) inputted to the microphone is measured and displayed in number, graphics or other forms on the screen.

The second embodiment treats item words, normalized expressions, hypernyms, and hyponyms as synonyms. Instead, words that are functionally close to each other, for example, superior-subordinate words found along a function tree as the one shown in FIG. 5, may be treated as synonyms. Alternatively, words representing events that are related in some way by a search, for example, television programs on-aired in the same time zone on different channels, or television programs on-aired in adjoining time zones on the same channel, may be treated as synonyms.

In the above embodiments, operation information provided by the pointing device 201, the microphone 202, or the operation keys 203 is sent by the operation information transmitting unit 204 to the controller 100 along with identification information to indicate which of 201, 202 and 203 has provided the operation information. Alternatively, three separate transmitting means may be provided to send operation information of the pointing device 201, operation information of the microphone 202, and operation information of the operation keys 203 separately, and the controller 100 may have three receiving means for the three transmitting means.

The functions of the controller 100 may be given to the television set 300. In the case where the television set 300 is a portable type, the television set 300 may have the functions of the operation terminal 200 in addition to the functions of the controller 100. In this case, the television set 300 is equipped with a key for selecting a displayed item, a key for entering the selected item, and a microphone through which an audio input is made, and information from the keys and information from the microphone are handed over to a controller unit incorporated in the television set 300.

The data base configuration, search items in a database and the like can also be modified in various ways. The embodiments of the present invention can receive various modifications within the range of the technical concept shown in the scope of claims.

What is claimed is:

1. A remote control system with an operation terminal and a controller which outputs control information for controlling an appliance in accordance with an operation command inputted to the operation terminal, comprising:
audio inputting means for inputting audio information;
instruction inputting means for selecting and designating an item displayed on a screen;
candidate creating means for creating a group of candidate items which can be options to choose from, from the audio information inputted to the audio inputting means;
image information creating means for creating image information from the candidate item group created by the candidate creating means;
display means for displaying, on the screen, the image information created by the image information creating means;
determining means for determining which control item in the candidate item group displayed on the screen by the display means is selected and designated by the instruction inputting means; and
control information outputting means for outputting control information according to the control item that is determined by the determining means.

2. A remote control system according to claim 1, wherein the candidate creating means includes:
database means for storing control items in association with keywords;
text composing means for composing text data by using the audio information inputted from the audio inputting means; and
candidate extracting means for comparing the text data composed by the text composing means against keywords of control items stored in the database means, and extracting as candidates to choose from, control items that contain keywords matching a character string in the text.

3. A remote control system according to claim 2, wherein the candidate extracting means checks, for each control item, the degree at which the character string in the text matches the keywords (matching degree), and extracts control items that are candidates to choose from in a descending order by the matching degree.

4. A remote control system according to claim 3, wherein the candidate extracting means counts, for each control item, how many of terms that are contained in the character string in the text match the keywords (matching count), and extracts control items that are candidates to choose from in a descending order by the matching count.

5. A remote control system according to any one of claims 2 through 4, wherein the text composing means includes voice recognizing means for creating text data by performing voice recognition on the audio information inputted to the audio inputting means, and presents, for the candidate extracting means, as text data to be compared against the keywords, a text data group consisting of N (N is a natural number) most similar voice recognition results having high resemblance to the inputted audio information.

6. A remote control system according to claim 1, wherein the candidate creating means includes a candidate group obtaining means for obtaining, from an external server, a group of candidate items that can be options to choose from by using the audio information inputted to the audio inputting means.

7. A remote control system according to claim 1, wherein the instruction inputting means includes a pointing device with which, when the operation terminal is pointed toward the screen, the pointed position is overlaid on the screen.

8. A remote control system according to claim 1, wherein the candidate creating means includes:
a synonym database for storing synonyms in association with keywords;
a control item database for storing control items in association with keywords;
text composing means for composing text data from the audio information inputted from the audio inputting means;
synonym displaying means for comparing the text data composed by the text composing means against keywords of synonyms stored in the synonym database to extract, as candidates to choose from, synonyms that are associated with keywords matching a character string in the text, and displaying the extracted synonyms on the screen as options to choose from; and
candidate extracting means for comparing synonyms that are designated by selection from the synonyms displayed on the screen by the synonym displaying means against keywords of control items stored in the control item database, and extracting, as candidates to choose from, control items that contain keywords matching a character string in the text.

9. A remote control system according to claim 8, wherein the candidate extracting means compares the synonyms that are designated by the selection designation information and other synonyms that are associated with keywords corresponding to the former synonyms in the synonym database against keywords of control items stored in the control item database, to thereby extract control items that are candidates to choose from.

10. A remote control system according to claim 8 or 9,
wherein the text composing means includes voice recognition means for creating text data by performing voice recognition of the audio information inputted by the audio inputting means, and presents, to the synonym displaying means, as text data to be compared against the keywords, a text data group consisting of N (N is a natural number) most similar voice recognition results having high resemblance to the inputted audio information, and
wherein the synonym displaying means extracts the synonyms that are candidates to choose from, for the N voice recognition results, and displays an image containing the synonyms and the voice recognition results both as options on the screen.

11. A remote control system according to claim 10, wherein the synonym displaying means causes the screen to display an image containing, as options, the N voice recognition results and synonyms for the recognition result that is at the top of the recognition priority order among the N voice recognition results.

12. A remote control system according to claim 11, wherein, when one of the N displayed recognition results is selected and designated, the synonym displaying means causes the screen to display synonyms for the selected and designated recognition result in place of the synonyms that have been displayed.

13. A controller which outputs control information to control an appliance in accordance with operation input information received from an operation terminal, comprising:
candidate creating means for creating a group of candidate items that can be options to choose from by using operation input information inputted with a voice and received from the operation terminal;
image information creating means for creating image information from the candidate item group created by the candidate creating means;
display means for displaying the image information created by the image information creating means on a screen;
determining means for determining which control item in the candidate item group displayed on the screen by the display means is selected and designated by the operation input information received from the operation terminal; and
control information outputting means for outputting control information according to the control item that is determined by the determining means.

14. A controller according to claim 13, wherein the candidate creating means includes:
database means for storing control items in association with keywords;
text composing means for composing text data by using the operation input information inputted with a voice and received from the operation terminal; and
candidate extracting means for comparing the text data composed by the text composing means against keywords of control items stored in the database means, and extracting, as candidates to choose from, control items that contain keywords matching a character string in the text.

15. A controller according to claim 14, wherein the candidate extracting means checks, for each control item, the degree at which the character string in the text matches the keywords (matching degree), and extracts control items that are candidates to choose from in a descending order by the matching degree.

16. A controller according to claim 15, wherein the candidate extracting means counts, for each control item, how many of terms that are contained in the character string in the text match the keywords (matching count), and extracts control items that are candidates to choose from in a descending order by the matching count.

17. A controller according to any one of claims 14 through 16, wherein the text composing means includes voice recognizing means for creating text data by performing voice recognition on the audio information inputted to the audio inputting means, and presents, for the candidate extracting means, as text data to be compared against the keywords, a text data group consisting of N (N is a natural number) most similar voice recognition results having high resemblance to the inputted audio information.

18. A controller according to claim 13, wherein the candidate creating means includes:
a synonym database for storing synonyms in association with keywords;
a control item database for storing control items in association with keywords;
text composing means for composing text data from the operation input information inputted with a voice and received from the operation terminal;
synonym displaying means for comparing the text data composed by the text composing means against keywords of synonyms stored in the synonym database to extract, as candidates to choose from, synonyms that are associated with keywords matching a character string in the text, and displaying the extracted synonyms on a screen as options to choose from; and
candidate extracting means for comparing synonyms that are designated by selection designation information sent from the operation terminal from the synonyms displayed on the screen by the synonym displaying means, against keywords of control items stored in the control item database, and extracting, as candidates to choose from, control items that contain keywords matching a character string in the text.

19. A controller according to claim 18, wherein the candidate extracting means compares the synonyms that are designated by the selection designation information and other synonyms that are associated with keywords corresponding to the former synonyms in the synonym database against keywords of control items stored in the control item database, to thereby extract control items that are candidates to choose from.

20. A controller according to claim 18 or 19,
wherein the text composing means includes voice recognition means for creating text data from voice recognition of the operation input information inputted with a voice, and presents, to the synonym displaying means, as text data to be compared against the keywords, a text data group consisting of N (N is a natural number) most similar voice recognition results having high resemblance to the audio input, and
wherein the synonym displaying means extracts the synonyms that are the candidates to choose from, for the N voice recognition results, and displays an image containing the synonyms and the voice recognition results both as options on the screen.

21. A controller according to claim 20, wherein the synonym displaying means causes the screen to display an image containing, as options, the N voice recognition results and synonyms for the recognition result that is at the top of the recognition priority order among the N voice recognition results.

22. A controller according to claim 21, wherein, when one of the N displayed recognition results is selected and designated, the synonym displaying means causes the screen to display synonyms for the selected and designated recognition result in place of the synonyms that have been displayed.

23. A program product which gives a computer a function of executing processings in accordance with operation input information received from an operation terminal, the processings comprising:
a candidate creating processing for creating a group of candidate items that can be options to choose from by using operation input information inputted with a voice and received from the operation terminal;
an image information creating processing for creating image information from the candidate item group created by the candidate creating processing;
a display processing for displaying the image information created by the image information creating processing on a screen;
a determining processing for determining which control item in the candidate item group displayed on the screen by the display processing is selected and designated by the operation input information received from the operation terminal; and
a control information outputting processing for outputting control information according to the control item that is determined by the determining processing to a target device.

24. A program product according to claim 23, comprising a database for storing control items in association with keywords,
wherein the candidate creating processing includes:
a text composing processing for composing text data by using the operation input information inputted with a voice and received from the operation terminal; and
a candidate extracting processing for comparing the text data composed by the text composing processing against keywords of control items stored in the database, as candidates to choose from, control items that contain keywords matching a character string in the text.

25. A program product according to claim 24, wherein the candidate extracting processing includes checking, for each control item, the degree at which the character string in the text matches the keywords (matching degree), and extracting control items that are candidates to choose from in a descending order by the matching degree.

26. A program product according to claim 25, wherein the candidate extracting processing includes counting, for each control item, how many of terms that are contained in the character string in the text match the keywords (matching count), and extracting control items that are candidates to choose from in a descending order by the matching count.

27. A program product according to any one of claims 24 through 26, wherein the text composing processing includes a voice recognizing processing for creating text data by performing voice recognition on the audio information inputted to the audio inputting processing, and includes presenting, for the candidate extracting processing, as text data to be compared against the keywords, a text data group consisting of N (N is a natural number) most similar voice recognition results having high resemblance to the inputted audio information.

28. A program product according to claim 23, further comprising:
a synonym database for storing synonyms in association with keywords; and
a control item database for storing control items in association with keywords,
wherein the candidate creating processing includes:
a text composing processing for composing text data from the operation input information inputted with a voice and received from the operation terminal;
a synonym displaying processing for comparing the text data composed by the text composing processing against keywords of synonyms stored in the synonym database to extract, as candidates to choose from, synonyms that are associated with keywords matching a character string in the text, and displaying the extracted synonyms on a screen as options to choose from; and
a candidate extracting processing for comparing synonyms that are designated by selection designation information sent from the operation terminal from the synonyms displayed on the screen by the synonym displaying processing, against keywords of control items stored in the control item database, and extracting control items that contain keywords matching a character string in the text.

29. A program product according to claim 28, wherein the candidate extracting processing includes comparing the synonyms that are designated by the selection designation information and other synonyms that are associated with keywords corresponding to the former synonyms in the synonym database against keywords of control items stored in the control item database, to thereby extract control items that are candidates to choose from.

30. A program product according to claim 28 or 29,
wherein the text composing processing includes a voice recognition processing for creating text data from voice recognition of the operation input information inputted with a voice, and includes presenting, to the synonym displaying processing, as text data to be compared against the keywords, a text data group consisting of N (N is a natural number) most similar voice recognition results having high resemblance to the audio input, and
wherein the synonym displaying processing includes extracting the synonyms that are candidates to choose from, for the N voice recognition results, and displaying an image containing the synonyms and the voice recognition results both as options on the screen.

31. A program product according to claim 30, wherein the synonym displaying processing includes causing the screen to display an image containing, as options, the N voice recognition results and synonyms for the recognition result that is at the top of the recognition priority order among the N voice recognition results.

32. A program product according to claim 31, wherein, when one of the N displayed recognition results is selected and designated, the synonym displaying processing includes causing the screen to display synonyms for the selected and designated recognition result in place of the synonyms that have been displayed.

33. A storage medium which stores a program that gives a computer a function of executing processings in accordance with operation input information received from an operation terminal, the processings comprising:
a candidate creating processing for creating a group of candidate items that can be options to choose from by using operation input information inputted with a voice and received from the operation terminal;
an image information creating processing for creating image information from the candidate item group created by the candidate creating processing;
a display processing for displaying the image information created by the image information creating processing on a screen;
a determining processing for determining which control item in the candidate item group displayed on the screen by the display processing is selected and designated by the operation input information received from the operation terminal; and
a control information outputting processing for outputting control information according to the control item that is determined by the determining processing to a target device.

34. A storage medium according to claim 33, comprising a database for storing control items in association with keywords,
wherein the candidate creating processing includes:
a text composing processing for composing text data by using the operation input information inputted with a voice and received from the operation terminal; and
a candidate extracting processing for comparing the text data composed by the text composing processing against keywords of control items stored in the database, and extracting, as candidates to choose from, control items that contain keywords matching a character string in the text.

35. A storage medium according to claim 34, wherein the candidate extracting processing includes checking, for each control item, the degree at which the character string in the text matches the keywords (matching degree), and extracting control items that are candidates to choose from in a descending order by the matching degree.

36. A storage medium according to claim 35, wherein the candidate extracting processing includes counting, for each control item, how many of terms that are contained in the character string in the text match the keywords (matching count), and extracting control items that are candidates to choose from in a descending order by the matching count.

37. A storage medium according to any one of claims 34 through 36, wherein the text composing processing includes a voice recognizing processing for creating text data by performing voice recognition on the audio information inputted to the audio inputting processing, and includes presenting, for the candidate extracting processing, as text data to be compared against the keywords, a text data group consisting of N (N is a natural number) most similar voice recognition results having high resemblance to the inputted audio information.

38. A storage medium according to claim 33, further comprising:
a synonym database for storing synonyms in association with keywords; and
a control item database for storing control items in association with keywords,
wherein the candidate creating processing includes:
a text composing processing for composing text data from the operation input information inputted with a voice and received from the operation terminal;
a synonym displaying processing in which the text data composed by the text composing processing is compared against keywords of synonyms stored in the synonym database to extract, as candidates to choose from, synonyms that are associated with keywords matching a character string in the text, and the extracted synonyms are displayed on a screen as options to choose from; and
a candidate extracting processing in which, of the synonyms displayed on the screen by the synonym displaying processing, synonyms that are associated with selection designation information sent from the operation terminal is compared against keywords of control items stored in the control item database, and control items that contain keywords matching a character string in the text are extracted as candidates to choose from.

39. A storage medium according to claim 38, wherein the candidate extracting processing includes comparing the synonyms that are designated by the selection designation information and other synonyms that are associated with keywords corresponding to the former synonyms in the synonym database against keywords of control items stored in the control item database, to thereby extract control items that are candidates to choose from.

40. A storage medium according to claim 38 or 39,
wherein the text composing processing includes voice recognition processing for creating text data from voice recognition of the operation input information inputted with a voice, and includes presenting, for the synonym displaying processing, as text data to be compared against the keywords, a text data group consisting of N (N is a natural number) most similar voice recognition results having high resemblance to the audio input, and
wherein the synonym displaying processing includes extracting the synonyms that are candidates to choose from, for the N voice recognition results, and displaying an image containing the synonyms and the voice recognition results both as options on the screen.

41. A storage medium according to claim 40, wherein the synonym displaying processing includes causing the screen to display an image containing, as options, the N voice recognition results and synonyms for the recognition result that is at the top of the recognition priority order among the N voice recognition results.

42. A storage medium according to claim 41, wherein, when one of the N displayed recognition results is selected and designated, the synonym displaying processing includes causing the screen to display synonyms for the selected and designated recognition result in place of the synonyms that have been displayed.

43. A server comprising:
communication means for communicating with a controller via a network;
candidate creating means for creating a group of candidate items that can be options to choose from by using audio information received from the controller; and
transmitting means for sending the candidate item group created by the candidate creating means to the controller by using the communication means.

44. A server according to claim 43,
wherein the candidate creating means includes, for each appliance, a database used in search for candidate items and, of these databases, a database for an appliance that can be a control target is set as a search database, from which a group of candidate items that can be options to choose from is obtained based on audio information received from the controller.

45. A server according to claim 44,
wherein the databases contain voice recognition dictionaries for voice recognition of the audio information, and
wherein the candidate creating means selects some of the voice recognition dictionaries that are for appliances that can be control targets, and merges the selected voice recognition dictionaries to obtain one voice recognition dictionary, which is set to be used in voice recognition of audio information received from the controller, and results of the voice recognition are used to obtain a group of candidate items that can be options to choose from.

46. A server according to claim 44 or 45, wherein the candidate creating means includes an appliance database in which appliance information is registered and sorted in association with user, and uses appliance information registered in the appliance database to specify databases associated with appliances that can be control targets.

47. A server according to claim 43,
wherein the candidate creating means includes:
status information obtaining means for obtaining, from the controller, information on an operation status of an appliance that can be control target; and
determining means for determining, from the obtained status information, whether a group of candidate items that can be control targets is appropriate or not, and
wherein a result of the determination is used to limit a group of control items that can be options to choose from.
